(19) United States
(12) Patent Application Publication
(10) Pub. No.: US 2016/0369104 A1
(43) Pub. Date: Dec. 22, 2016

(54) TRANSPARENT POLYMER HARDCOATS AND CORRESPONDING TRANSPARENT FILMS

(71) Applicant: C3Nano Inc., Hayward, CA (US)

(72) Inventors: Hua Gu, Dublin, CA (US); Xiqiang Yang, Hayward, CA (US); Wen Lin Kwek, Singapore (SG); Faraz Azadi Manzour, Berkeley, CA (US); Ajay Virkar, San Francisco, CA (US)

(21) Appl. No.: 14/741,119

(22) Filed: Jun. 16, 2015

(51) Int. Cl. C09D 4/06; C09D 7/12; C09D 5/00

(52) U.S. Cl. CPC C09D 4/06; C09D 5/00; C09D 7/1216; C09D 7/1266

(57) ABSTRACT

Hardcoat formulations are described that cure into interpenetrating crosslinked acrylate polymers and crosslinked epoxy polymers. The epoxy polymers can comprise polysiloxane moieties and/or aliphatic moieties. The acrylate polymers can comprise aliphatic moieties and/or urethane moieties. UV initiator compounds can be used to initiate the curing process upon exposure to UV light. The resulting hardcoat materials are found to exhibit desirable properties. The hardcoat material can be placed over sparse metal transparent conductive layers to provide protection to the conductive layers.

### FIELD OF THE INVENTION

The invention relates to polymer hardcoats with a selected blend of polymers to provide a range of desirable properties. The invention further relates to transparent conductive layers protected by the polymer hardcoats.

### BACKGROUND OF THE INVENTION

Transparent polymer films are used in a wide range of products. While the films can serve many purposes, generally the films provide some protection from various mechanical and/or environmental assaults. Protection provided by the film can be directed both to underlying structure as well as the film itself since, for example, a scratched surface of the film can degrade the desired performance of the film by decreasing transparency and increasing blurring or haze. Protection of surfaces can be significant both in use of the ultimate product as well as during processing to form the product and transporting components for assembly into the product.

Functional films can provide important roles in a range of contexts. For example, electrically conductive films can be important for the dissipation of static electricity when static can be undesirable or dangerous. Optical films can be used to provide various functions, such as polarization, anti-reflection, phase shifting, brightness enhancement or other functions. High quality displays can comprise one or more optical coatings.

Transparent conductors can be used for several optoelectronic applications including, for example, touch-screens, liquid crystal displays (LCD), flat panel display, organic light emitting diode (OLED), solar cells and smart windows. Historically, indium tin oxide (ITO) has been the material of choice due to its relatively high transparency at high conductivities. There are however several shortcomings with ITO. For example, ITO is a brittle ceramic which needs to be deposited using sputtering, a fabrication process that involves high temperatures and vacuum and therefore can be relatively slow. Additionally, ITO is known to crack easily on flexible substrates.

### SUMMARY OF THE INVENTION

In a first aspect, the invention pertains to a coating composition comprising at least about 7 weight percent solvent, acrylate monomers having at least two acrylate functional groups, epoxy functionalized polysiloxane with at least two epoxide groups, a radical photoinitiator, and a cationic photoinitiator.

In a further aspect, the invention pertains to a coating on a substrate comprising a crosslinked polymer composition having crosslinked polyacrylate moieties, and at least about 10 weight percent epoxy-crosslinked polysiloxane moieties.

In an additional aspect, the invention pertains to a transparent conductive film comprising a transparent substrate, a sparse metal conductive layer and a cured coating having a thickness from about 25 nm to about 15 microns. The cured coating generally comprises a blend of crosslinked polyacrylate moieties, crosslinked epoxy moieties and polysiloxane moieties.

### BRIEF DESCRIPTION OF THE DRAWINGS

FIG. 1 is a fragmentary side view of a film with a sparse metal conductive layer and various additional transparent layers on either side of the sparse metal conductive layer.

FIG. 2 is a top view of a representative schematic patterned structure with three electrically conductive pathways formed with sparse metal conductive layers.

FIG. 3 is a schematic diagram showing a capacitance based touch sensor.

FIG. 4 is a schematic diagram showing a resistance based touch sensor.

FIG. 5 is a plot of percent curing as a function of time for three polymer hardcoats, two formulated hardcoats under the teachings herein and one commercial hardcoat.

FIG. 6 is a photograph of a cracked sample formed with a commercial hardcoat following a bending test.

FIG. 7 is a photograph of a hardcoat coated substrate free of cracks following a bending test.

### DETAILED DESCRIPTION

Desirable polymer hardcoats are described that effectively combine chemistries of epoxies and acrylates, as well as optionally polysiloxanes and/or polyurethanes, in a highly crosslinked polymer coating. The polymer can be conveniently solvent coated with subsequent processing to form a crosslinked polymer coating. The coating precursor solutions are compatible with the introduction of nanoscale fillers that can be included in the coatings to alter the qualities of the coating consistent with good optical properties. For example, nanoparticles, like TiO₂, SiO₂ and nanodiamonds can be added to provide increased hardness, and nanoscale metal fillers, pigments, and other materials can contribute color control, although other property enhancing fillers are further described below. The hardcoats can be effectively used as coatings over transparent conductive films. Transparent conductive films can be formed from metal nanowires to form sparse metal conductive layers. Fused metal conductive networks formed from metal nanowire inks have been found to provide very desirable properties with respect to electrical conductivity, optical properties, effective processing, patterning and stability. The crosslinked hardcoats described herein are found to be suitable for stabilization of sparse metal conductive layers.

Transparent polymer films can be an important component for a variety of passive applications as well as for electrical devices the transmit light, such as displays, touch sensors and the like, and receive light, such as photodetectors, photovoltaics and the like. Transparent films can include a hardcoat to reduce the vulnerability to scratching, other physical assaults and generally environmental assaults. Various polymer chemistries can be used for the hardcoats, and the chemistries of the hardcoats described herein provide desirable properties. Transparent conductive films can be significant commercial components for a growing number of consumer electronic devices along with various other products. Traditional transparent conductive films generally are based on electrically conductive metal oxides, such as indium tin oxide (ITO) and aluminum doped zinc oxide (AZO). Growing commercially accepted transparent conductive films are based on metal nanowires, generally silver nanowires. Hardcoats can be applied over the transparent conductive films to both physically protect the transparent conductive layer during further processing and potentially during transportation prior to additional processing as well as to stabilize the transparent conductive film during use and corresponding aging. With polymer chemistries as described herein, hardcoats with cured thickness generally on the order of about 10 microns or less can have good optical properties. The coatings can be formed with appropriate coating processes, such as those known in the art, as described further below.

Polyacrylates can be effectively used to form highly crosslinked polymers. The acrylates polymerize based on vinyl groups with the reaction driven by free radical processes. Two bonds can form from a vinyl group along the polymer backbone, but two or more acrylate groups on a monomer can crosslink the resulting polymer. Ultraviolet light (UV) free radical initiators can be used to drive the crosslinking with UV light treatment following the drying of a coated layer of the hardcoat precursor composition. In the desirable hardcoats described herein, a highly crosslinked acrylate component can be formed in some embodiments using highly branched acrylate monomers. Acrylates generally have good mechanical strength and can have good optical transparency.

Also, as described further below, in addition to or as an alternative to other acrylate monomers, pendant acrylate groups can be placed on urethane oligomers to effectively introduce urethane properties to the product hard coatings. The urethane acrylate polymerizes with the other acrylate contributing components for incorporation into the polymerized acrylate network. In these embodiments, the cured coating comprises urethane oligomer moieties, having carbamate linkages, within the polymer networks. Polyurethane moieties can be desirable in embodiments in which a higher resiliency is desired. For embodiments to obtain a desirably clear coating, the urethane oligomers can be free of aromatic groups, e.g., the hydrocarbon chains can be aliphatic.

Epoxy polymers can also provide good mechanical strength. Epoxies can involve polymerization reactions involving an epoxide functional group and optionally active hydrogen atoms, such as in a hydroxide group or a primary or secondary amine. The epoxide functional groups can self polymerize, and a cationic UV activated catalyst can be used to initiate the self-polymerization process. For polymerization, monomers with multiple functional groups are appropriate. The epoxide functional group is a three member cyclic ether with two carbon atoms on vertices of the ring. The polymerization of epoxide functional groups generally produces ether moieties. In some embodiments, epoxy monomers can be diglycidyl ethers of alkyl glycols.

In some embodiments, in addition to or as an alternative to other epoxy monomers, the epoxide groups can be situated on polysiloxane moieties. In the examples below, the polysiloxane moieties are polysiloxane cage structures with an epoxide functional group linked to selected vertices of the cage. The cage structures provides for curing to form a highly branched polymer structures around the siloxane cage. Alternatively, other polysiloxane compounds modified with epoxide functional groups can be used as reactants. The polysiloxane cage structures with the epoxide functional groups can be conveniently processed with the solvent systems compatible with the other hardcoat components. However, polysiloxanes generally can be hydrophobic and can repel water. It can be desirable in some uses to reduce water interaction with the films protected by the hardcoating.

The precursor coating solution can comprise a suitable solvent to form a blend of the polymer precursor components that are dissolved in the solvent and to obtain desirable properties for coating or printing the coating composition. Suitable solvents can comprise, for example, alcohols, such as isopropanol, higher alcohols, glycol ethers, and mixtures thereof. Generally, the coating solutions comprise at least about 7 weight percent solvent. Solvents are generally volatile, while other coating composition components generally have negligible or no volatility at room temperature.

The hardcoat precursor composition can be deposited using any reasonable coating or printing process, as described further below. Knife edge coating, slot coating, gravure printing or the like can be a desirable processing approach for formation of polymer sheets with a hardcoat, which can comprise a sparse metal conductive layer. The precursor coating thickness can be selected to yield a desired thickness of the dried and cured hardcoat, which depends in part on the amount of solvent that evaporates during drying.

The dried hardcoat material can then be cured, which generally involves initiation of polymerization, which may result in crosslinking of the polymers. Generally, UV light is used to drive the curing process, and heat may or may not be applied additionally or alternatively to the UV light. The crosslinking generally forms interpenetrating acrylate polymers, e.g., crosslinked acrylates, and crosslinked epoxy polymers. The UV curing can be performed with a suitable UV lamp, such as are available in curing stations for polymer webs. The crosslinking conditions can be selected to achieve desired crosslinking, as described further below.

It has been found that nanoscale fillers can be effectively included in hardcoats to provide desirable adjustment in some properties. As described herein, coatings with nanoscale fillers can be formed with a modest drop in total transmission of visible light. In some embodiments, the nanoscale fillers can be property enhancing fillers that can improve hardness, increase thermal conductivity, and/or change the dielectric constant. In particular, nanodiamonds have been found to significantly increase hardness and stability of transparent conductive layers adjacent a nanodiamond loaded hardcoat. Polymer films with a hardcoat loaded with nanodiamonds have been found to maintain good flexibility under standard testing while providing good hardness. Various other ceramic nanoparticles are described below with respect to providing hardness, thermal conductivity and/or a higher dielectric constant. Graphene also can provide very high thermal conductivity. In additional or alternative embodiments, suitable nanoscale fillers are nanoscale colorants that can be included in the hardcoat to adjust the color of the associated film, which may or may not be directed to having whiter transmitted light. Metal nanostructures, such as metal nanoplates, have been found to be effective as nanoscale colorants without significantly altering overall optical properties. Fillers can comprise a mixture of property enhancing nanoparticles and nanoscale colorants.

The transparent hardcoat is applied to a substrate, which in general can be any reasonable material, generally a transparent material. Suitable materials can include glass, such as silicate glasses, or polymer sheets or films. Additional layers of compositions can be applied in the formation of a film. In some embodiments, the hardcoat is applied onto a transparent electrically conductive layer, which can be a film of conductive oxide or other transparent conductive film. In embodiments of particular interest, the transparent conductive film can comprise a sparse metal conductive layer. Sparse metal conductive layers can be formed from metal nanowires, such as silver nanowires. It has been found that fused metal nanostructured networks are a particularly desirable form of sparse metal conductive layers. In some embodiments, polymer hardcoat may also be blended with the precursor solutions for forming the sparse metal conductive layer.

For the formation of transparent electrically conductive layers, various sparse metal conductive layers can be formed from metal nanowires. Metal nanowires can be formed from a range of metals, and metal nanowires are available commercially or can be synthesized. While metal nanowires are inherently electrically conducting, the vast majority of resistance in the metal nanowires based films is believed to due to the junctions between nanowires. Depending on processing conditions and nanowire properties, the sheet resistance of a relatively transparent nanowire film, as deposited, can be very large, such as in the giga-ohms/sq range or even higher. Various approaches have been proposed to reduce the electrical resistance of the nanowire films without destroying the optical transparency.

Films formed with metal nanowires that are processed to flatten the nanowires at junctions to improve conductivity is described in U.S. Pat. No. 8,049,333 to Alden et al., entitled “Transparent Conductors Comprising Metal Nanowires,” incorporated herein by reference. Structures comprising surface embedded metal nanowires to increase metal conductivity are described in U.S. Pat. No. 8,748,749 to Srinivas et al., entitled “Patterned Transparent Conductors and Related Manufacturing Methods,” incorporated herein by reference. However, desirable properties have been found for fused metal nanostructured networks with respect to high electrical conductivity and desirable optical properties with respect to transparency and low haze. Fusing of adjacent metal nanowires can be performed based on chemical processes at low temperatures under commercially appropriate processing conditions.

In particular, a significant advance with respect to achieving electrically conductive films based on metal nanowires has been the discovery of well controllable processes to form a fused metal network where adjacent sections of the metal nanowires fuse. Fusing of metal nanowires with various fusing sources is described further in published U.S. patent applications 2013/0341074 to Virkar et al., entitled “Metal Nanowire Networks and Transparent Conductive Material,” and 2013/0342221 to Virkar et al. (the '221 application), entitled “Metal Nanostructured Networks and Transparent Conductive Material,” 2014/0238833 to Virkar et al. (the '833 application), entitled “Fused Metal Nanostructured Networks, Fusing Solutions with Reducing Agents and Methods for Forming Metal Networks,” and copending U.S. patent application Ser. No. 14/087,669 to Yang et al. (the '669 application), entitled “Transparent Conductive Coatings Based on Metal Nanowires, Solution Processing Thereof, and Patterning Approaches,” copending U.S. patent application Ser. No. 14/448,504 to Li et al, entitled “Metal Nanowire Inks for the Formation of Transparent Conductive Films with Fused Networks,” all of which are incorporated herein by reference.

The transparent conductive films generally can comprise several components or layers that contribute to the processability and/or the mechanical properties of the structure without detrimentally altering the optical properties. The sparse metal conductive layers can be designed to have desirable optical properties when incorporated into the transparent conductive films. The sparse metal conductive layer may or may not further comprise a polymer binder. Unless otherwise indicated, references to thicknesses refer to average thicknesses over the referenced layer or film, and adjacent layers may intertwine at their boundaries depending on the particular materials. In some embodiments, the total film structure can have a total transmission of visible light of at least about 85%, a haze of no more than about 2 percent and a sheet resistance of no more than about 250 ohms/sq, although significantly better performance is described herein.

The coatings are generally formed by solution coating. Various coating and/or printing techniques can be adapted for the formation of the hardcoating. To obtain a coating with desirable optical properties, the hardcoat can be formed with a thickness generally of no more than about 10 microns, although often a submicron coating thickness can be effective. Unless noted otherwise, thickness refers to an average thickness of a coating or other layer.

In general, the hardcoats are transparent to visible light and have desirable optical properties. In particular, at the relevant thicknesses, the hardcoat materials can have a high transparency to visible light, a low haze with relatively no contribution to color. Property enhancing filler can be introduced with little or no effect on transparency, haze and color, although nanoscale colorants can introduce color to compensate in a desired way. Then in combination with other components of a transparent film, the overall film can maintain good transparency to visible light and low haze as well as a roughly white transmitted light if desired. The hardcoats can provide protection for a range of transparent films. With respect to hardness, the protection can be evaluated in the context of pencil hardness, scratch resistance or the like.

In the context of coating over a sparse metal conductive layer, instability seems associated with a restructuring of the metal in the conductive element that results in a lowering of electrical conductivity, which can be measured as an increase in sheet resistance. Thus, the stability can be evaluated in terms of the amount of an increase in sheet resistance over time. A particular commercial accelerated test apparatus and commonly accepted conditions in the apparatus are described in detail below. The test apparatus provides an intense light source, heat and humidity in a controlled environment. Under the relatively stringent conditions of the test, the transparent conductive elements can exhibit an increase in sheet resistance of no more than about 30% in 600 hours and an increase of no more than about 75% in 1200 hours.

It has been found that particular instabilities occur at portions of a film that is covered, which can correspond to an edge of a transparent conductive film of an actual device where electrical connections to the transparent conductive film are made and hidden from view. The covered portions of the transparent conductive film are heated when the covered film is subjected to lighted conditions, and the heat is believed to contribute to some of the instabilities that are addressed herein.

Transparent, electrically conductive films find important applications, for example in solar cells and touch screens. Transparent conductive films formed from metal nanowire components offer the promise of lower cost processing and more adaptable physical properties relative to traditional materials. In a multilayered film with various structural polymer layer(s), the resulting film structure has been found to be robust with respect to processing while maintaining desirable electrical conductivity, and the incorporation of desirable components as described herein can additionally provide stabilization without degrading the functional properties of the film so that devices incorporating the films can have suitable lifetimes in normal use.

Thus, the hardcoats can be incorporated effectively into films for various application for transparent films, such as touch sensors, photovoltaics, displays generally and the like. The hardcoat precursor compositions are suitable for application and curing using commercial coating equipment. As shown in the Examples below, the hardcoats can be effective to protect transparent conductive films including films with sparse metal conductive layers.

### Hardcoat Precursor Compositions

The hardcoat precursor solutions comprise a suitable solvent and soluble polymer precursor compositions that can be monomers or oligomers. The polymer precursors comprise acrylate precursors and epoxy precursors. Optionally, the precursors solution can further comprise epoxy functionalized polysiloxane and/or acrylate functionalized polyurethane, which provide properties to the coating attributable to polysiloxanes or polyurethanes while relying on the epoxy or acrylate curing chemistries. The precursor solution comprises appropriate activators/catalysts to facilitate curing the polymer upon exposure to appropriate radiation, such as ultraviolet light. Specifically, a radical initiator can be used to drive the acrylate polymerization/crosslinking and a cationic initiator can be used to drive the epoxy polymerization/crosslinking. The properties of the precursor solutions, for example, concentration, can be adjusted to provide for appropriate coating processes. Solvents can be selected that are compatible with the various precursor compounds such that the precursor compounds are dissolved in the solvent. The precursor solutions can be loaded with property enhancing particulates, which can be well dispersed nanoparticulates.

Solvents can be identified in the precursor solution based on some volatility at room temperature. Since the solvents are volatile and the hardcoat precursor is dried prior to curing, it is expected that the solvent does not participate in the polymerization/crosslinking reactions. Solvents are generally organic and selected to dissolve the polymer precursor compositions. The coatings are generally dried before UV exposure to crosslink the coatings, so the solvents do not participate in the crosslinking reactions. Solvent blends can be useful. Suitable organic solvents include, for example, toluene, hexanes, alcohols, such as isopropyl alcohol, ketones, such as methylethyl ketone, esters, such as ethyl acetate, ethers, such as glycol ethers, and mixtures thereof. Glycol ethers include, for example, ethylene glycol monomethyl ether, ethylene glycol monoethyl ether, propylene glycol monomethyl ether, or the like, or combinations thereof. The other components of the precursor solution besides the solvents can be collectively referred to as the solid content.

Generally, the precursor solution comprises at least about 7 weight percent solvent, in further embodiments, at least about 10 weight percent solvent, in additional embodiments from about 12.5 weight percent to about 99.9 percent solvent and in other embodiments from about 15 weight percent solvent to about 99.75 weight percent solvent. A person of ordinary skill in the art will recognize that additional ranges within the explicit ranges above of the solvent component of the precursor solution are contemplated and are within the present disclosure. The relative amount of solvent present in the precursor solution influences the dry thickness of the coating relative to the wet thickness of the coating as deposited. Thus, the solvent content can be adjusted at least in part to select a dry coating thickness for a particular coating method. The amount of solvent can also be adjusted to alter the fluid properties of the precursor solution. To decouple the solvent content from the proportion of solids in the precursor solution, the amounts of the other components of the precursor solution are generally referenced relative to the weight percent of the solid content. Also, the concentrations in this section with respect to both the solvent and the other dissolved non-volatile coating components exclude any solid, undissolved, fillers that are described in the next section. Thus, the solids following solvent removal comprises both non-volatile dissolved components of the precursor solution, which can be referred to as non-volatile precursor components, and any solid fillers.

In general, suitable acrylate precursors can include, for example, polyol esters, e.g., branched polyol esters, of acrylic acid. With respect to the acrylate monomers/oligomers, the ester groups generally are methyl esters or ethyl esters, although other ester groups can be used. The precursor solutions can optionally further comprise acrylate functionalized polyurethane compounds, and these are discussed further below. In some embodiments, the precursor solution can comprise monomers generally having one or more acrylate groups on a hydrocarbon backbone. If the precursor compounds have two or more functional groups, the acrylate compound can crosslink into a polymer network during curing. The precursor solution can comprise a blend of precursor compounds. In some embodiments, the acrylate precursor can comprise a hydrocarbon backbone with a sufficient molecular weight such that the compound is a solid as specified above. In some embodiments, an acrylate monomer can comprise 2 or more acrylate groups, in further embodiments at least 3 acrylate groups, in other embodiments at least 4 acrylate groups, in additional embodiments at least 5 acrylate groups, in further embodiments at least 6 acrylate groups, moreover at least 7 acrylate groups, or mixtures thereof.

With respect to acrylate monomers with hydrocarbon backbones, examples of the precursor compounds include, for example, trifunctional, tetrafunctional and pentafunctional acrylates, which are available from Sartomer Americas (PA, USA) or Esstech. Examples of these multifunctional compounds include, for example, pentaerythritol triacrylate, trimethylolpropane triacrylate, di-trimethylol propane tetraacrylate, dipentaerythritol pentaacrylate, pentaerythritol tetracrylate, pentaacrylate ester, and mixtures thereof. Dipentaerythritol hexaacrylate and other multifunctional acrylate monomers are available from Double Bond Chemicals Ind. Co., ltd. (Taiwan). A mixture of dipentaerythritol pentaacrylate and dipentaerythritol hexaacrylate as well as a range of acrylate monomers with lower degrees of functionalities are available from Nippon Kayaku Co., Ltd. (Japan). Multifunctional acrylate monomers are also available from IGM resins, such as tris(2-hydroxyethyl)isocyanurate triacrylate, dipentaerythritol hexaacrylate, or glycerol triacrylate. These suppliers also offer a large range of commercial difunctional acrylate monomers such as butanediol diacrylate, butanediol dimethacrylate, hexanediol diacrylate, hexanediol dimethacrylate, diethylene diacrylate, triethylene diacrylate, neopentyl glycol diacrylate, neopentyl glycol dimethacrylate, and the like and mixtures thereof. The precursor solution can comprise from about 10 weight percent to about 90 weight percent, in further embodiments from about 15 weight percent to about 85 weight percent, and in other embodiments from about 20 weight percent to about 82.5 weight percent polyol ester acrylate precursors of the residue content of the precursor solution. A person of ordinary skill in the art will recognize that additional ranges within the explicit ranges above are considered and are within the present disclosure.

The acrylates polymerize/crosslink through the reaction of vinyl groups associated with the ester groups. The reaction of the functional groups can be effectively driven with a suitable radical catalyst, which can be activated with UV light. Commercially available radical catalysts include, for example, the IRGACURE line of photoinitiators from BASF, such as IRGACURE 500 (blend of 1-hydroxy-cyclohexyl-phenyl-ketone and benzophenone), IRGACURE 651 (α,α-Dimethoxy-α-phenylacetophenone), IRGACURE 369 (2-Benzyl-2-dimethylamino-1[4-(4-morpholinyl)phenyl]-1-butanone) and IRGACURE TPO (2,4,6-triethylbenzylphenylphosphinic acid ethyl ester), Doublecure series of photoinitiators from Double Bond Chemical Ind., Co., Ltd. (Taiwan) such as Doublecure TPO, Doublecure 184, Doublecure 575, and Doublecure 200, and the Omnirad series of photoinitiators available from IGM Resins, such as Omnirad 1000 (blend of 2-hydroxy-2-methyl-1-phenylpropanone and 1-hydroxy-cyclohexyl-phenyl-ketone). The precursor solution can comprise radical catalyst from about 0.1 weight percent to about 15 weight percent, in further embodiments from about 0.2 weight percent to about 13.5 weight percent and in other embodiments from about 0.25 weight percent to about 12 weight percent or radical catalyst as a fraction of the residue content of the precursor solution. A person of ordinary skill in the art will recognize that additional ranges of radical catalyst concentrations within the explicit ranges above are contemplated and are within the present disclosure.

Epoxy precursors have an epoxide group, which can also be referred to as a glycidyl ether group or oxirane group, which is a cyclic ether —CHCH₂O. Some epoxy resins are based on polyphenols modified to have at least two epoxide groups, although other aromatic and aliphatic groups can support the epoxy precursors. In some embodiments, epoxy modified polysiloxanes are optionally included in the precursor solutions to provide desirable coating properties associated with the polysiloxane moiety. With respect to aromatic, e.g., polyphenol, based precursors, suitable precursors include, for example, epoxidized bisphenol A (bisphenol A diglycidyl ether), epoxidized bisphenol F (bisphenol F diglycidyl ether), novolock resins, which are the epoxidied reaction product of formaldehyde and aromatic alcohols (e.g., phenol or cresol), glycidyl amines (e.g., triglycidyl-p-aminophenol or N,N,N,N-tetraglycidyl-4,4-methylenebis benzylamine), or the like or mixtures thereof. Novolac compounds and glycidyl aromatic amines can have more than two functional groups, such as 3, 4, 5, 6 or more functional groups, which can provide crosslinking ability. While widely used aromatic epoxy monomers can be used for the hardcoatings, to obtain hardcoats with better optical transparency, it can be desirable to use epoxies with aliphatic hydrocarbon cores since aromatic groups can contribute to some extent in the absorption of visible light. Various aliphatic epoxy monomers are available commercially. For example, neopentyl diglycidyl ether, 1,4-butanediol diglycidyl ether, 1,6-hexanediol diglycidyl ether, polypropylene glycol diglycidyl ether, and trimethylol propane triglycidyl ether are available from Novel Chemicals (India), and 1,3-butanediol diglycidyl ether, ethylene glycol diglycidyl ether, 1,5-hexadiene diepoxide and 1,7-octadiene diepoxide are available from TCI America. In general, alcohols or amines can be epoxidized, i.e. formed into epoxide groups, using epichlorhydrin, which has the IUPAC name chloromethyloxirane. With respect to hydrocarbon based epoxy compounds, the precursor solutions can comprise from about 0.25 weight % to about 55 weight percent, in further embodiments, from about 0.4 weight % to about 50 weight percent and in additional embodiments from about 0.5 weight % to about 45 weight % hydrocarbon based epoxy compounds as a fraction of the residue content of the precursor solution. A person of ordinary skill in the art will recognize that additional ranges of hydrocarbon-based epoxy precursor concentrations within the explicit ranges above are contemplated and are within the present disclosure. The hydrocarbon backbones can be halogenated, e.g., brominated.

While the epoxy groups can react with hydroxyl groups and amine groups, the epoxy groups can react with each other with an appropriate catalyst. Epoxy catalysts are commercially available or can be supplied based on known epoxy chemistry. Suitable cationic catalysts can be used with UV curing and include, for example, diaryliodonium salts that have the structure [Ar—I—Ar]⁺X⁻, where Ar corresponds with an aryl group. Commercial cationic catalysts are available, for example, from Polyset (Mechanicville, N.Y., USA), IGM Resins USA, Inc. (IL, USA), and Chitec Technology Corp. (Taiwan). In particular, Polyset offers the 2500 series of diaryliodonium and diarylsulfonium catalysts, such as PC-2506 ([4-(2-hydroxyl)-(1-tetradodecyl)-phenyl]phenyl iodonium hexafluoroantimonate). IGM Resins offers Ominicat 440 (4,4′-dimethyl-diphenyl iodonium hexafluorophosphate) and Omini430 (mixed triarylsulfonium hexafluorophosphate salts). Chitec offers Chivacure 1176 (mixture of Diphenyl(4-phenylthio) phenylsulfonium hexafluoroantimonate and (Thiodi-4,1-phenylene)bis(diphenylsulfonium) dihexafluoroantimonate). The precursor solution can comprise from about 0.1 weight % to about 10 weight %, in further embodiments from about 0.25 weight percent to about 9 weight % and in additional embodiments from about 0.5 weight percent to about 8 weight % cationic catalyst as a fraction of the residue content of the precursor solution. A person of ordinary skill in the art will recognize that additional ranges of cationic catalyst concentrations in the precursor solutions are contemplated and are within the present disclosure.

Epoxy functionalized polysiloxanes can be included in the precursor solution to provide properties associated with the polysiloxanes to the hardcoating. The epoxy functionalization can provide both crosslinking of the compounds into the epoxy network as well as adjusting the solubility of the precursor compound. The polysiloxanes are generally of modest size to obtain appropriate solubilities of the compounds. For example, the polysiloxanes can have molecular weights in some embodiments from about 600 g/mole to about 5000 g/mole and in additional embodiments from about 800 g/mole to about 4000 g/mole. A person of ordinary skill in the art will recognize that additional ranges of molecular weights within the explicit ranges above are contemplated and are within the present disclosure. Terminal hydroxyl groups can be formed into epoxide groups with epichlorhydrin. Linear polysiloxanes with two epoxide groups polymerize as linear addition polymers, and branched polysiloxanes with three or more epoxide groups can be used to form crosslinked epoxies with a degree of crosslinking based on the degree of branching of the precursor. Epoxy functionalized polysiloxane oligomers are described, for example, in U.S. Pat. No. 7,893,183B2 to Lejuene et al. entitled “Epoxy Silane Oligomer and Coating Composition Containing Same,” and U.S. Pat. No. 8,728,345B2 to Iyer et al, entitled “Epoxy-Containing Polysiloxane Oligomer Compositions, Process for Making the Same and Uses Thereof,” both of which are incorporated herein by reference. In some embodiments, it is desirable to use epoxy functionalized cage polysiloxanes. Glycidyl POSS® epoxy functionalized polysiloxane cage compounds are available commercially from Hybrid Plastics, Inc. (MS, U.S.A.). For example, POSS® EPO408 and EPO409 have an octagonal polysiloxane cage with an epoxy cyclohexylethyl group (EPO408) or —CH₂CH₂CH₂OCH₂-cyclo(CHCH₂O) (EPO409) moieties at each vertex of the cage. Additionally, octa[(1,2-epoxy-4-ethylcyclohexyDdimethylsiloxy] substituted POSS®, and octa[(3-glycidyloxypropyl)dimethylsiloxy] substituted POSS® are available from Sigma-Aldrich (Missouri, USA).

In some embodiments, the precursor composition can comprise one or more epoxy functionalized polysiloxane compositions. For these embodiments, the precursor compositions can comprise from about 0.5 weight percent to about 45 weight percent, in further embodiments from about 1 weight percent to about 40 weight percent and in additional embodiments from about 2 weight percent to about 35 weight percent epoxy functionalized polysiloxane as a function of the residue content of the precursor solution. A person of ordinary skill in the art will recognize that additional ranges of epoxy functionalized polysiloxane concentrations within the explicit ranges above are contemplated and are within the present disclosure.

The precursor compositions may also comprise acrylate di-functionalized urethane polymer. Urethane polymers have organic repeating units joined by carbamate or urethane linkages, i.e., —(O—R—NH—CO—)ₙ or —(O—R′—OCONH—R″—NH—CO—)ₙ, where R, R′ and R″ are organic groups, in which the linkage can be formed through the reaction of an isocyanate group with an alcohol group. The acrylate functional groups are CH₂CHCOO—. A variety of urethane oligomers can be used, and a particular compound is exemplified below. A range of aliphatic urethane acrylates are available, for example, from Sartomer (Arkema Group, PA, USA), Double Bond Chemical and IGM Resins. For example, DM 588 from Double Bond Chemical is an aliphatic urethane acrylate (10 functional groups), Photomer 6625 from IGM resins is an aliphatic urethane acrylate (6 functional group), and Photomer 6892 from IGM resins is an aliphatic urethane acrylate (3 functional group). The acrylate functionalized urethane polymers can be polymerized and/or crosslinked along with the other acrylate reactants with a radical UV catalyst, as described above. If present, the precursor solution can comprise from about 1 weight percent to about 60 weight percent, in further embodiments from about 2 weight percent to about 55 weight percent and in further embodiment from about 4 weight percent to about 50 weight percent as a fraction of the residue composition in the precursor solution. A person of ordinary skill in the art will recognize that additional ranges of acrylate functionalized urethanes within the explicit ranges above are contemplated and are within the present disclosure. Urethane acrylate monomers with multiple functional groups usually can improve curing speed, hardness, scratch resistance and environmental durability, also can improve the adhesion on substrate.

### Fillers

It has been found that nanoscale fillers can be added to the precursor solution to alter the properties of the resulting coating. The nanoscale, generally nanoparticulate, fillers are generally suspended solids in the solution. In particular, nanoscale fillers can provide hardness, thermal conductivity, increased dielectric constant, and/or hue adjustment. For convenience, nanoscale fillers that provide hardness, thermal conductivity or increased dielectric constant can be referred to collectively as property enhancing nanoparticles, while nanoscale fillers that adjust hue can be referred to as nanoscale colorants. Nanodiamonds have been found to be effective to increase hardness, and it is believed that coatings with nanodiamonds exhibit improved thermal conductivity. Noble metal nanoplates, nanoshells and the like have been found to be useful to adjust hue, i.e., color, for transparent films. Additional nanoscale fillers are described below. The overcoats with nanoscale fillers can be useful for a range of applications. In particular, the property enhancing fillers can be very helpful for protection of transparent conductive layers formed with sparse metal conductive layers, and nanoscale colorants can adjust for color of transparent conductive layers to provide a whiter film or to provide another desired color change.

The use of nanodiamonds in coatings for transparent films is described further in copending U.S. patent application Ser. No. 14/577,669 to Virkar et al., entitled “Property Enhancing Fillers for Transparent Coatings and Transparent Conductive Films,” incorporated herein by reference. Nanoscale colorants as fillers for transparent coatings are described further in copending U.S. patent application 14/6276,400 to Yang et al. (the '400 application), entitled “Transparent Films with Control of Light Hue Using Nanoscale Colorants,” incorporated herein by reference. The results herein demonstrate that a polymer sheet with a nanodiamond loaded hardcoat can provide a high pencil hardness while remaining flexible. In particular, the film with the hardcoat can be flexed repeatedly without cracking.

With respect to desirable fillers, nanodiamonds are of particular interest due to hardness and thermal conduction properties that can be introduced into the hardcoat consistent with maintaining good optical transparency and relatively low haze. Diamond is a crystalline form of carbon with sp³ hybridized orbitals, in contrast with graphitic carbon, amorphous carbon and other forms of carbon. Commercial nanodiamonds generally can have a core of crystalline diamond carbon with a shell of amorphous and/or graphitic carbon, and are dielectrics. The surface chemistry of the nanodiamonds can reflect the synthesis approach and possibly additional processing. Commercial nanodiamonds, which can be functionalized or unfunctionalized following purification, are available from various suppliers as listed below. Moreover, it is possible to change the surface using a variety of chemistries. Nanodiamonds share with macroscopic diamonds very high values of hardness and thermal conductivity, and these properties can be used to deliver desirable properties to transparent coatings incorporating nanodiamonds.

Nanodiamonds are commercially available with average primary particle diameters generally no more than about 50 nm and in some embodiments no more than about 10 nm, although nanodiamonds may be useful in some embodiments with average primary particle diameters of no more than about 100 nm. As used herein unless indicated otherwise, particle diameters are an average of values along the principle axes of the particle, which can be roughly estimated from transmission electron micrographs. Commercial nanodiamonds are produced synthetically with possible surface modification, and their overall structure can be confirmed using spectroscopic techniques. Surface modification of the nanodiamonds can be useful for processing of the nanodiamonds and for compatibility with particular solvents and binders. The commercial nanodiamonds can be well dispersed in a range of solvents for the production of high quality optical coatings with good transparency and low haze. Other nanoparticle fillers can have average particle diameters over the same ranges as the nanodiamonds. The nanoparticles can have roughly spherical shapes or other convenient shapes. A person of ordinary skill in the art will recognize that additional ranges within the explicit average particle diameter ranges above for nanodiamonds or other property enhancing nanoparticles are contemplated and are within the present disclosure.

Synthetic nanodiamonds can be produced by several means. For example, vapor phase formation such as chemical vapor deposition, ion irradiation of graphite, chlorination of carbides, and techniques using shock wave energies are some of the several possible methods to produce such diamond particles or thin nanodiamond films. In addition to diamond nanoparticles of rough spherical form, other 1- and 2-dimensional nanodiamond structures had been fabricated such as nanodiamond rods, sheets, flakes, and the like, which can also be used in UV protecting compositions (on methods of synthesis of these structures see O. Shenderova and G. McGuire, “Types of Nanodiamonds”, book chapter in “Ultrananocrystalline diamond: Synthesis, Properties and Applications”, Editors: O. Shenderova, D. Gruen, William-Andrews Publisher, 2006), incorporated herein by reference). Commercial nanodiamond particles are generally formed by controlled explosive techniques, such as described in U.S. Pat. No. 5,916,955 to Vereschagin et al., entitled “Diamond-Carbon Material and Method for Producing Thereof,” incorporated herein by reference. Improved purification methods for detonation nanodiamonds are described, for example, in published PCT application, WO 2013/135305 to Dolmatov et al., entitled “Detonation Nanodiamond Material Purification Method and Product Thereof,” incorporated herein by reference. Commercial nanodiamonds with various surface chemistries or dispersed in ranges of solvents are available from NanoCarbon Research Institute Co., Ltd. (Japan), PlasmaChem (Germany), Carbodeon Limited OY (Finland), NEOMOND (Korea), Sigma-Aldrich (USA), and Ray Techniques Ltd. (Israel).

The nanodiamonds can provide a desirable degree of hardness and thermal conductivity to a composite coating incorporating the nanodiamonds. Also, diamonds are a good dielectric so that a nanodiamond composite coating can facilitate dissipation of strong electric fields that can damage films in the structure. Other nanoparticles can be similarly introduced to provide similar properties to composites incorporating the functional nanoparticles consistent with good optical transparency of a resulting coating. For the formation of transparent conductive films, other suitable nanoparticles for providing hardness include but not limited to, for example, boron nitride, B₄C, cubic-BC₂N, silicon carbide, crystalline alpha-aluminum oxide (sapphire), or the like. Hardness contributing nanoparticles can be formed from a bulk material having a Vickers hardness of at least about 1650 kgf/mm² (16.18 GPa). While these very hard materials can be particularly desirable for providing a hardcoat composition, but other ceramic nanoparticles can provide sufficient hardness in some coating formulations, such as nanoparticles of silica (SiO₂), zirconia (ZeO₂), titania (TiO₂) and the like.

With respect to thermal conductivity, in addition to nanodiamonds, graphene, silicon nitride, boron nitride, aluminum nitride, gallium arsenide, indium phosphide and mixtures thereof can be suitable for introducing high thermal conductivity. In some embodiments, high thermal conductivity materials can have a bulk thermal conductivity of at least about 30 W/(m·K), and graphene and diamond have among the highest thermal conductivities known. Particularly high dielectric constant materials that can be introduced as nanoparticles include but not limited to, for example, barium titanate, strontium titanate, lead titanate, lead zirconium titanate, calcium copper titanate and mixtures thereof. With respect to the hardness of the protective polymer based coatings, hardness can be measured with the pencil hardness test for films, as described further below. Scratch resistance is also evaluated with the use of steel wool.

Relevant nanoparticles are generally available commercially. Nanoparticles sources include, for example, US Research Nanomaterials, Inc. (Texas, USA), which sells many of the materials of interest, BYK-Chemie GMbH. (Germany), Sigma-Aldrich (Missouri, USA), Nanostructured and Amorphous Materials (Texas, USA), Sky Spring Nano Materials Inc. (Texas, USA) and Nanophase Technologies Corp. (Romeoville, Ill., USA). Also, laser pyrolysis techniques have been developed for the synthesis of a wide range of dispersible nanoparticles, as described in U.S. Pat. No. 7,384,680 to Bi et al., entitled “Nanoparticle-Based Powder Coatings and Corresponding Structures,” incorporated herein by reference.

The nanoparticles, such as the nanodiamonds, can be dispersed and then the dispersion of nanoparticles can be blended with the coating solution of the polymer binder, although processing orders may be suitable depending on the selection of solvent and the dispersion properties of the particles. The property enhancing nanoparticles in the coating precursor solution can have a concentration in the ranges from about 0.005 wt % to about 5.0 wt %, in further embodiments from about 0.0075 wt % to about 1.5 wt % and in additional embodiments from about 0.01 wt % to about 1.0 wt %. A person of ordinary skill in the art will recognize that additional ranges of concentrations within the explicit ranges above are contemplated and are within the present disclosure.

Nanoscale colorants can be useful to improve the neutral color of a transparent film or to introduce a desired hue. For example, with a transparent conductive layer, nanoscale colorants can compensate for color introduced by the conductive layer. With respect to the use of a nanoscale colorant to improve the whiteness of transmitted light through a transparent conductive film, the pigment can be selected to have a small compensating absorption and/or scattering complementary to the absorption/scattering of the conductive material.

Color spaces can be defined to relate spectral wavelengths to human perception of color. CIELAB is a color space determined by the International Commission on Illumination (CIE). The CIELAB color space uses a three-dimensional set of coordinates, L*, a* and b*, where L* relates to the lightness of the color, a* relates to the position of the color between red and green, and b* relates to the position of the color between yellow and blue. The “*” values represent normalized values relative to a standard white point. These CIELAB parameters can be determined using commercial software from measurements made in a spectrophotometer.

Based on CIELAB parameters, in principle, the films can be engineered to get a desired degree of whiteness, generally based on a small absolute value of b* and a* in the CIELAB scale. However, in view of practical limitations, design of the films can direct the results to produce whiter light within certain desired ranges (absolute values of b* and a* lower than target cutoff values), as has been achieved with nanoscale colorants. As explained further below, reasonable values of whiteness can be obtained with acceptable decreases in total transmission of visible light.

Nanoscale colorants can be, for example, nanoscale metal structures or nanoscale pigments. Nanoscale metal structures generally have at least one average dimension that is no more than about 100 nm. For example, nanoplates have an average thickness of no more than 100 nm, nanoribbons can have a thickness of no more than about 100 nm and possibly a width of no more than 100 nm. Metal nanoplates can be synthesized using solution based techniques and their optical properties have been examined. See, for example, published U.S. patent applications 2012/0101007 to Ahern et al., entitled “Silver Nanoplates,” and 2014/0105982 to Oldenburg et al., entitled “Silver Nanoplate Compositions and Methods,” both of which are incorporated herein by reference. Silver nanoplates with tuned absorption properties based on surface plasmon resonances are available commercially from nanoComposix, Inc., San Diego, Calif., USA, Beijing Nanomeet Technology Co. Ltd., China, and Suzhou ColdStones Technology Co., Ltd., China. Similarly, nanoplates can be synthesize directly, such as using known synthesis techniques, as for example, Kelly, J. M., et al., ACTA PHYSICA POLONICA A, (2012), 122, 337-345, “Triangular Silver Nanoparticles: Their Preparation, Functionalisation and Properties”; Jiang, Li-Ping, et al., Inorg. Chem., (2004), 43, 5877-5885, “Ultrasonic-Assisted Synthesis of Monodisperse Single-Crystalline Silver Nanoplates and Gold Nanorings”; and Xiong, Y., et al., Langmuir 2006 (20): 8563-8570, “Poly(vinyl pyrrolidone): a dual functional reductant and stabilizer for the facile synthesis of noble metal nanoplates in aqueous solutions,” all three of which are incorporated herein by reference. As reported by nanoComposix, the nanoplates have thicknesses of about 10 nm and respectively (equivalent circular) diameters of 40-60 nm (550 nm nanoplates) or 60-80 nm (650 nm nanoplates). Some commercial nanoplates can be obtained with either a polyvinylpyrrolidone (PVP) coating or with a silica (silicon oxide) coating. In general, silver nanoplates with either coating are observed to yield desirable results, although the results with silica coated 550 nm absorbing nanoplates seem to provide a desirable decrease in the magnitude of b* with a desirably small increase in the magnitude of a*. Examples are presented in the '400 application cited above for films incorporating the 550 nm nanoplates, the 650 nm nanoplates or a combination thereof.

Metal nanoshells can be formed over silica or similar ceramic nanoparticle cores. Commercial gold nanoshells over silica are commercially available from nanoComposix, Sigma-Aldrich, and Nanospectra Biosciences, Inc. Houston, Tex., USA. The gold nanoshell forms a plasmon tunable material to introduce desired spectral properties. These materials can provide hue adjustment with modest decrease in light transmission and little increase in haze and possibly a decrease in haze. Solid gold nanoparticles are available commercially, for example, from NanoHybrids, Austin, Tex., Nanopartz Inc., Loveland, CO. PlasmaChem GmbH, Germany. Silver nanoribbons, which can be referred to as nanobelts, are also commercially available, from nanoComposix. In general, specially shaped metal nanostructures may be formed according to a variety of different methods, for example, gold nanoshells may be prepared according to published procedures, for example, Hah et al., Gold Bulletin (2008), 41/1, 23-36, “Synthesis of gold nanoshells based on the deposition precipitation process”.

A wide range of pigments are known and used for a wide range of commercial applications, and development of new pigments continues. Pigments are characterized by the significant insolubility in at least some reasonable solvent so that the pigments can be dispersed as particulates. The pigments can be inorganic, organic or organometallic. Some pigments can be processed to form nanoscale particulates or are commercially available with appropriate particle sizes. In some embodiments, nanopigments are crystalline compounds, which bestow color analogously to conventional pigments, but directly synthesized at the nanoscale (e.g., 10-50 nm). Examples of Nanopigments have been described in Cavalcante et al., Dyes and Pigments, (2009), 80, 226-232, entitled “Colour Performance of Ceramic Nano-pigments”, and Gardini et al., Journal of Nanoscience and Nanotechnology, (2008), 8, 1979-1988, entitled “Nano-sized ceramic inks for drop-on-demand ink-jet printing in quadrichromy”, both incorporated herein by reference.

Similarly, the nanoscale colorant can be selected to introduce a desired hue or color rather than white light. For appropriate embodiments, the intrinsic contribution to the color based on an electrically conductive layer of a transparent conductive film can be factored into the selection of the pigment and loading of the pigment to achieve a desired color, which can be expressed by the b* and a* values in the CIELAB system. The selected hues can be patterned appropriately for a particular application, such as a display or the like.

For processing, the nanoscale colorants can be dispersed in a hardcoat precursor solution, for example, to form the hardcoat. In some embodiments, a dispersion of nanoplates or other nanoscale colorant can be first dispersed and then added to a solution of the other components. The concentration of nanoscale colorants can be selected to yield a desired loading in the eventual resulting layer formed from the coating solution. Based on concentrations of the coating solution, the wet coating thickness can be selected to yield a desired dry coating thickness based on the empirical decrease in coating thickness upon drying and further processing. A hardcoat precursor solution can comprise from about 0.0001 wt % to about 2 wt % nanoscale colorants, in further embodiments from about 0.00025 wt % to about 1 wt % and in additional embodiments from about 0.0005 wt % to about 0.5 wt % nanoscale colorants. A person of ordinary skill in the art will recognize that additional ranges of stabilization compound in a coating solution within the explicit ranges above are contemplated and are within the present disclosure.

### Transparent Conductive Films

The transparent electrically conductive structures or films generally can comprise a sparse metal conductive layer that provides the electrical conductivity without significantly adversely altering the optical properties and various additional layers that provide mechanical support as well as protection of the conductive element. A polymer overcoat can be placed over the sparse metal conductive layer. The nanoscale fillers as described herein can be placed in an overcoat layer, an undercoat layer and/or directly into the sparse metal conductive layer. In additional embodiments, an electrically conductive layer can comprise conductive metal oxides as a film or as particulates. In some embodiments, a sparse metal conductive layer can comprise a fused metal nanostructured network to provide desired electrical conductivity with good optical properties with a relatively stable structure.

Transparent electrically conductive elements, e.g., films, can comprise a sparse metal conductive layer in some embodiments. The conductive layers are generally sparse to provide desired amount of optical transparency, so the coverage of the metal has very significant gaps within the layer of the conductive element. For example, transparent electrically conductive films can comprise metal nanowires deposited along a layer where sufficient contact can be provided for electron percolation to provide suitable conduction pathways. In other embodiments, the transparent electrically conductive film can comprise a fused metal nanostructured network, which has been found to exhibit desirable electrical and optical properties. In general, the nanowires can be formed from a range of metals, such as silver, gold, indium, tin, iron, cobalt, platinum, palladium, nickel, cobalt, titanium, copper and alloys thereof, which can be desirable due to high electrical conductivity. Commercial metal nanowires are available from Sigma-Aldrich (Missouri, USA), Cangzhou Nano-Channel Material Co., Ltd. (China), Blue Nano (North Carolina, U.S.A.), EMFUTUR (Spain), Seashell Technologies (California, U.S.A.), Aiden (Korea), nanoComposix (U.S.A.), Nanopyxis (Korea), K&B (Korea), ACS Materials (China), KeChuang Advanced Materials (China), and Nanotrons (USA). Alternatively, silver nanowires can also be synthesized using a variety of known synthesis routes or variations thereof.

For appropriate embodiments, a sparse metal conductive layer can be formed on a substrate that can have one or more layers in the structure of the substrate. The substrate generally can be identified as a self supporting film or sheet structure. A thin solution processed layer, referred to as an undercoat, can be optionally placed along the top surface of the substrate film and immediately under the sparse metal conductive layer. Also, the sparse metal conductive can be coated with one or more additional layers that provide some protection on the side of the sparse metal conductive layer opposite the substrate. In general, the electrically conductive structure can be placed in either orientation in the final product, i.e., with the substrate facing outward or with the substrate against the surface of the product supporting the electrically conductive structure. In some embodiments, a plurality of coatings, e.g., undercoats and/or overcoats, can be applied, and each layer independently may or may not have selected nanoscale fillers.

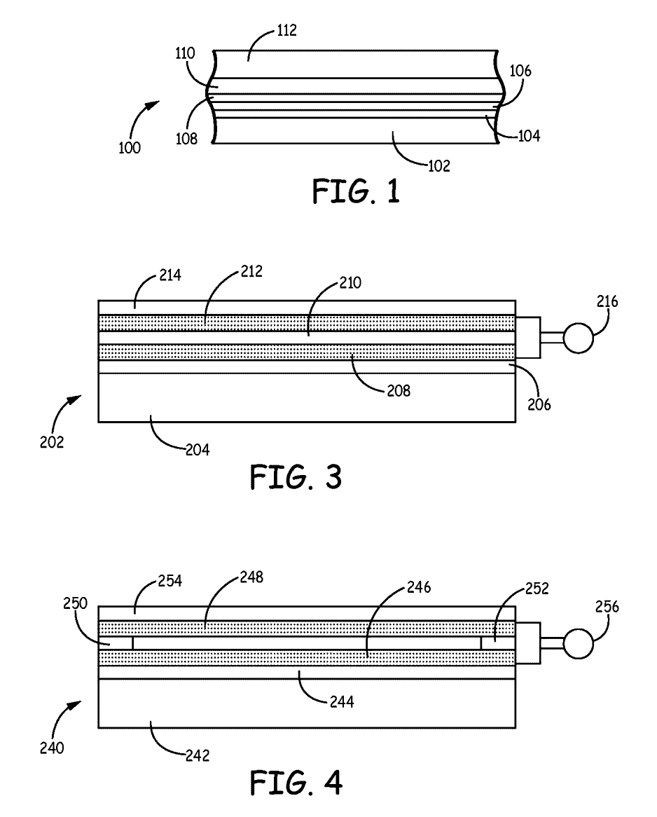

Referring to FIG. 1, representative transparent conductive film 100 comprises a substrate 102, undercoat layer 104, sparse metal conductive layer 106, overcoat layer 108, optically clear adhesive layer 110 and protective surface layer 112, although not all embodiments include all layers. A transparent conductive film generally comprises a sparse metal conductive layer and at least one layer on each side of the sparse metal conductive layer. The total thickness of the transparent conductive film can generally have a thickness from 10 microns to about 3 millimeters (mm), in further embodiments from about 15 microns to about 2.5 mm and in other embodiments from about 25 microns to about 1.5 mm. A person of ordinary skill in the art will recognize that additional ranges of thicknesses within the explicit ranges above are contemplated and are within the present disclosure. In some embodiments, the length and width of the film as produced can be selected to be appropriate for a specific application so that the film can be directly introduced for further processing into a product. In additional or alternative embodiments, a width of the film can be selected for a specific application, while the length of the film can be long with the expectation that the film can be cut to a desired length for use. For example, the film can be in long sheets or a roll. Similarly, in some embodiments, the film can be on a roll or in another large standard format and elements of the film can be cut according to a desired length and width for use.

Substrate 102 generally comprises a durable support layer formed from an appropriate polymer or polymers. In some embodiments, the substrate can have a thickness from about 10 microns to about 1.5 mm, in further embodiments from about 15 microns to about 1.25 mm and in additional embodiments from about 25 microns to about 1 mm. A person of ordinary skill in the art will recognize that additional ranges of thicknesses of the substrate within the explicit ranges above are contemplated and are within the present disclosure. Suitable optically clear polymers with very good transparency, low haze and good protective abilities can be used for the substrate. Suitable polymers include, for example, polyethylene terephthalate (PET), polyethylene naphthalate (PEN), polycarbonate (PC), polyacrylate, poly(methyl methacrylate), polyolefin, polyvinyl chloride, fluoropolymers, polyamide, polyimide, polysulfone, polysiloxane, polyetheretherketone, polynorbornene, polyester, polystyrene, polyurethane, polyvinyl alcohol, polyvinyl acetate, acrylonitrile-butadiene-styrene copolymer, cyclic olefin polymer, cyclic olefin copolymer, polycarbonate, copolymers thereof or blend thereof or the like. Suitable commercial polycarbonate substrates include, for example, MAKROFOL SR243 1-1 CG, commercially available from Bayer Material Science; TAP® Plastic, commercially available from TAP Plastics; and LEXAN™ 8010 CDE, commercially available from SABIC Innovative Plastics. Protective surface layer 112 can independently have a thickness and composition covering the same thickness ranges and composition ranges as the substrate as described in this paragraph above.

Optional undercoat 104 and/or optional overcoat 108, independently selectable for inclusion, can be placed respectively under or over sparse metal conductive layer 106. Optional coatings 104, 108 can comprise a curable polymer, for example, the UV curable hardcoat materials described herein. Coatings 104, 108 can have a thickness from about 25 nm to about 2 microns, in further embodiments from about 40 nm to about 1.5 microns and in additional embodiments from about 50 nm to about 1 micron. More generally, the hardcoat polymers can be formed into coatings having thicknesses from about 25 nm to about 15 microns, in further embodiments from about 40 nm to about 10 microns and in additional embodiments from about 50 nm to about 5 microns. A person of ordinary skill in the art will recognize that additional ranges of overcoat/undercoat thicknesses within the explicit ranges above are contemplated and are within the present disclosure. In general, the thinness of overcoat 108 allows for electrical conduction through overcoat 108 so that electrical connection can be made to sparse metal conductive layer 106, although in some embodiments, an overcoat can comprise sublayers in which electrical conductivity is provided through some but not necessarily all of the sublayers.

Optional optically clear adhesive layer 110 can have a thickness from about 10 microns to about 300 microns, in further embodiments from about 15 microns to about 250 microns and in other embodiments from about 20 microns to about 200 microns. A person of ordinary skill in the art will recognize that additional ranges of thicknesses of optically clear adhesive layers within the explicit ranges above are contemplated and are within the present disclosure. Suitable optically clear adhesives can be contact adhesives. Optically clear adhesives include, for example, coatable compositions and adhesive tapes. UV curable liquid optically clear adhesives are available based on acrylic or polysiloxane chemistries. Suitable adhesive tapes are available commercially, for example, from Lintec Corporation (MO series); Saint Gobain Performance Plastics (DF713 series); Nitto Americas (Nitto Denko) (LUCIACS CS9621T and LUCIAS CS9622T); DIC Corporation (DAITAC LT series OCA, DAITAC WS series OCA and DAITAC ZB series); PANAC Plastic Film Company (PANACLEAN series); Minnesota Mining and Manufacturing (3M, Minnesota U.S.A.—product numbers 8146, 8171, 8172, 8173 and similar products) and Adhesive Research (for example product 8932).

The amount of nanowires delivered onto the substrate for sparse metal conductive layer 106 can involve a balance of factors to achieve desired amounts of transparency and electrical conductivity. While thickness of the nanowire network can in principle be evaluated using scanning electron microscopy, the network can be relatively sparse to provide for optical transparency, which can complicate the measurement. In general, the sparse metal conductive structure, e.g., fused metal nanowire network, would have an average thickness of no more than about 5 microns, in further embodiments no more than about 2 microns and in other embodiments from about 10 nm to about 500 nm. However, the sparse metal conductive structures are generally relatively open structures with significant surface texture on a submicron scale. The loading levels of the nanowires can provide a useful parameter of the network that can be readily evaluated, and the loading value provides an alternative parameter related to thickness. Thus, as used herein, loading levels of nanowires onto the substrate is generally presented as milligrams of nanowires for a square meter of substrate. In general, the metal conductive networks, whether or not fused, can have a loading from about 0.1 milligrams (mg)/m² to about 300 mg/m², in further embodiments from about 0.5 mg/m² to about 200 mg/m², and in other embodiments from about 1 mg/m² to about 150 mg/m². The transparent conductive layer can comprise from about 0.05 wt % to about 70 wt % metal, in other embodiments from about 0.075 wt % to about 60 wt % and in further embodiments from about 0.1 wt % to about 50 wt % metal in a conductive network. A person of ordinary skill in the art will recognize that additional ranges of thickness, metal loading and concentrations within the explicit ranges above are contemplated and are within the present disclosure.

If the sparse metal conductive layer is patterned, the thickness and loading discussion applies only to the regions where metal is not excluded or significantly diminished by the patterning process. The sparse metal conductive layer can comprise nanoscale fillers in addition to a polymer binder and other processing aids and the like. Ranges of concentration of nanoscale fillers described above for loadings in transparent polymer layers generally also apply to sparse metal conductive layers. Expressed another way, the weight ratio of metal nanowires used to form a sparse metal conductive element to nanoscale fillers can be from about 250:1 to about 5:1 and in further embodiments from about 100:1 to about 10:1. It is possible that in relevant embodiments metal nanostructures incorporated into the sparse metal conductive layer may or may not fuse or partially fuse into the fused metal nanostructured network, although unless explicitly stated references to metal nanostructures in a layer with a fused metal nanostructured network refer generally to the structure whether or not the metal nanostructures fuse into the network. As described in the '400 application cited above, in some embodiments, no significant changes in electrical conductivity or color expectations are observed with the introduction of metal nanoplates in the sparse metal conductive layer. Correspondingly, references to metal nanostructures as nanoscale colorants do not refer to metal nanowires incorporated into the conductive layer.

Generally, within the total thicknesses above for particular components of film 100, layers 102, 104, 106, 108, 110, 112 can be subdivided into sublayers, for example, with different compositions from other sublayers. For example, an overcoat layer can comprise sublayers with different fillers. Thus, more complex layer stacks can be formed. Sublayers may or may not be processed similarly to other sublayers within a particular layer, for example, one sublayer can be laminated while another sublayer can be coated and cured. For example, a coating can be supplied with a nanoscale colorant and a further layer over this layer can be supplied with a property enhancing nanoparticles, such as a nanodiamond to provide protective hardness.

For some applications, it is desirable to pattern the electrically conductive portions of the film to introduce desired functionality, such as distinct regions of a touch sensor. Patterning can be performed by changing the metal loading on the substrate surface either by printing metal nanowires at selected locations with other locations being effectively barren of metal or to etch or otherwise ablate metal from selected locations either before and/or after fusing the nanowires if the nanowires are fused in the particular embodiment. For appropriate embodiments, it has been discovered that high contrast in electrical conductivity can be achieved between fused and unfused portions of a layer with essentially equivalent metal loading so that patterning can be performed by selectively fusing the metal nanowires. This ability to pattern based on fusing provides significant additional patterning options based on selective fusing of the nanowires, for example, through the selective delivery of a fusing solution or vapor. Patterning based on selective fusing of metal nanowires is described in the '833 application and the '669 application above.

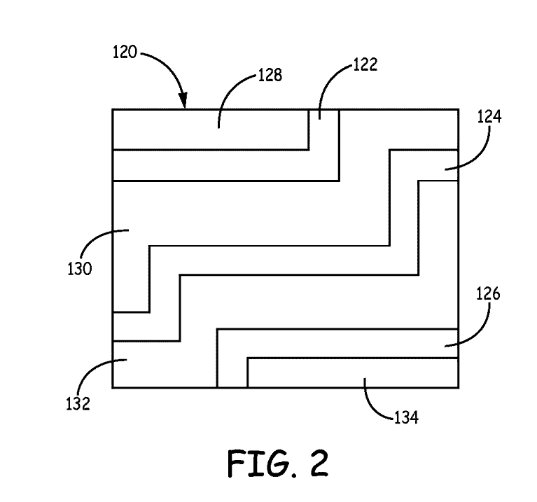

As a schematic example, a fused metal nanostructured network can form conductive patterns along a substrate surface 120 with a plurality of electrically conductive pathways 122, 124, and 126 surrounded by electrically resistive regions 128, 130, 132, 134, as shown in FIG. 2. As shown in FIG. 2, the fused area correspond with three distinct electrically conductive regions corresponding with electrically conductive pathways 122, 124, and 126. Although three independently connected conductive regions have been illustrated in FIG. 2, it is understood that patterns with two, four or more than 4 conductive independent conductive pathways or regions can be formed as desired. For many commercial applications, fairly intricate patterns can be formed with a large number of elements. In particular, with available patterning technology adapted for the patterning of the films described herein, very fine patterns can be formed with highly resolved features. Similarly, the shapes of the particular conductive regions can be selected as desired.

The transparent conductive film is generally built up around the sparse metal conductive element which is deposited to form the functional feature of the film. Various layers are coated, laminated or otherwise added to the structure using appropriate film processing approaches. The deposit of the sparse metal conductive layer is described further below in the context of a fused metal nanostructured layers, but un-fused metal nanowire coatings can be similarly deposited except that the fusing components are absent.

The sparse metal conductive layer generally is solution coated onto a substrate, which may or may not have a coating layer on top of the substrate which then forms an undercoat adjacent the sparse metal conductive layer. A hardcoat can be solution coated with a polymer precursor solution noted above onto the sparse metal conductive layer. Crosslinking, for example with application of UV light and/or heat, can be performed to crosslink the hardcoat polymers and/or the sparse metal conductive layer, which can be performed in one step or multiple steps.

### Sparse Metal Conductive Layers

Sparse metal conductive layers are generally formed from metal nanowires. With sufficient loading and selected nanowire properties, reasonable electrical conductivity can be achieved with the nanowires with corresponding appropriate optical properties. It is expected that the film structures described herein can yield desirable performance for films with various sparse metal conductive structures. However, particularly desirable properties have been achieved with fused metal nanostructured networks.

As summarized above, several practical approaches have been developed to accomplish the metal nanowire fusing. The metal loading can be balanced to achieve desirable levels of electrical conductivity with good optical properties. In general, the metal nanowire processing can be accomplished through deposition of two inks with the first ink comprising the metal nanowires and the second ink comprising a fusing composition, or through the deposition of an ink that combines the fusing elements into the metal nanowire dispersion. The inks may or may not further comprise additional processing aids, binders or the like. Suitable patterning approaches can be selected to be suitable for the particular ink system.

In general, one or more solutions or inks for the formation of the metal nanostructured network can collectively comprise well dispersed metal nanowires, a fusing agent, and optional additional components, for example, a polymer binder, a crosslinking agent, a wetting agent, e.g., a surfactant, a thickener, a dispersant, other optional additives or combinations thereof. The solvent for the metal nanowire ink and/or the fusing solution if distinct from the nanowire ink can comprise an aqueous solvent, an organic solvent or mixtures thereof. In particular, suitable solvents include, for example, water, alcohols, ketones, esters, ethers, such as glycol ethers, aromatic compounds, alkanes, and the like and mixtures thereof. Specific solvents include, for example, water, ethanol, isopropyl alcohol, isobutyl alcohol, tertiary butyl alcohol, methyl ethyl ketone, glycol ethers, methyl isobutyl ketone, toluene, hexane, ethyl acetate, butyl acetate, ethyl lactate, PGMEA (2-methoxy-1-methylethylacetate), dimethyl carbonate, or mixtures thereof. While the solvent should be selected based on the ability to form a good dispersion of metal nanowires, the solvents should also be compatible with the other selected additives so that the additives are soluble in the solvent. For embodiments in which the fusing agent is included in a single solution with the metal nanowires, the solvent or a component thereof may or may not be a significant component of the fusing solution, such as alcohols and can be selected accordingly if desired.

The metal nanowire ink, in either a one ink or two ink configuration, can include from about 0.01 to about 1 weight percent metal nanowires, in further embodiments from about 0.02 to about 0.75 weight percent metal nanowires and in additional embodiments from about 0.04 to about 0.5 weight percent metal nanowires. A person of ordinary skill in the art will recognize that additional ranges of metal nanowire concentrations within the explicit ranges above are contemplated and are within the present disclosure. The concentration of metal nanowires influences the loading of metal on the substrate surface as well as the physical properties of the ink.

In general, the nanowires can be formed from a range of metals, such as silver, gold, indium, tin, iron, cobalt, platinum, palladium, nickel, cobalt, titanium, copper and alloys thereof, which can be desirable due to high electrical conductivity. Silver in particular provides excellent electrical conductivity, and commercial silver nanowires are available. Alternatively, silver nanowires can also be synthesized using a variety of known synthesis routes or variations thereof. To have good transparency and low haze, it is desirable for the nanowires to have a range of small diameters. In particular, it is desirable for the metal nanowires to have an average diameter of no more than about 250 nm, in further embodiments no more than about 150 nm, and in other embodiments from about 10 nm to about 120 nm. With respect to average length, nanowires with a longer length are expected to provide better electrical conductivity within a network. In general, the metal nanowires can have an average length of at least a micron, in further embodiments, at least 2.5 microns and in other embodiments from about 5 microns to about 100 microns, although improved synthesis techniques developed in the future may make longer nanowires possible. An aspect ratio can be specified as the ratio of the average length divided by the average diameter, and in some embodiments, the nanowires can have an aspect ratio of at least about 25, in further embodiments from about 50 to about 10,000 and in additional embodiments from about 100 to about 2000. A person of ordinary skill in the art will recognize that additional ranges of nanowire dimensions within the explicit ranges above are contemplated and are within the present disclosure.

Polymer binders and the solvents are generally selected consistently such that the polymer binder is soluble or dispersible in the solvent. In appropriate embodiments, the metal nanowire ink generally comprises from about 0.02 to about 5 weight percent binder, in further embodiments from about 0.05 to about 4 weight percent binder and in additional embodiments from about 0.1 to about 2.5 weight percent polymer binder. In some embodiments, the polymer binder comprises a crosslinkable organic polymer, such as a radiation crosslinkable organic polymer and/or a heat curable organic binder. To facilitate the crosslinking of the binder, the metal nanowire ink can comprise in some embodiments from about 0.0005 wt % to about 1 wt % of a crosslinking agent, in further embodiments from about 0.002 wt % to about 0.5 wt % and in additional embodiments from about 0.005 wt % to about 0.25 wt %. The nanowire ink can optionally comprise a rheology modifying agent or combinations thereof. In some embodiments, the ink can comprise a wetting agent or surfactant to lower the surface tension, and a wetting agent can be useful to improve coating properties. The wetting agent generally is soluble in the solvent. In some embodiments, the nanowire ink can comprise from about 0.01 weight percent to about 1 weight percent wetting agent, in further embodiments from about 0.02 to about 0.75 weight percent and in other embodiments from about 0.03 to about 0.6 weight percent wetting agent. A thickener can be used optionally as a rheology modifying agent to stabilize the dispersion and reduce or eliminate settling. In some embodiments, the nanowire ink can comprise optionally from about 0.05 to about 5 weight percent thickener, in further embodiments from about 0.075 to about 4 weight percent and in other embodiments from about 0.1 to about 3 weight percent thickener. A person of ordinary skill in the art will recognize that additional ranges of binder, wetting agent and thickening agent concentrations within the explicit ranges above are contemplated and are within the present disclosure.

A range of polymer binders, including the hardcoat polymers described herein, can be suitable for dissolving/dispersing in a solvent for the metal nanowires. Suitable classes of radiation curable polymers and/or heat curable polymers include, for example, polyurethanes, acrylic resins, acrylic copolymers, cellulose ethers and esters, other water insoluble structural polysaccharides, polyethers, polyesters, epoxy containing polymers, and mixtures thereof. Examples of commercial polymer binders include, for example, NEOCRYL® brand acrylic resin (DMS NeoResins), JONCRYL® brand acrylic copolymers (BASF Resins), ELVACITE® brand acrylic resin (Lucite International), SANCURE® brand urethanes (Lubrizol Advanced Materials), cellulose acetate butyrate polymers (CAB brands from Eastman™ Chemical), BAYHYDROL™ brand polyurethane dispersions (Bayer Material Science), UCECOAT® brand polyurethane dispersions (Cytec Industries, Inc.), MOWITOL® brand polyvinyl butyral (Kuraray America, Inc.), Dexerials brand hardcoat polymers (Dexerials, Japan), Kisco hard coat materials (Kisco Ltd., Japan), California Hard Coat (USA), JNC hardcoat polymers (Japan), and JSR Corp. (Japan) hardcoat polymers, such as KZ6445A, KZ6412 and Z7541, cellulose ethers, e.g., ethyl cellulose or hydroxypropyl methyl cellulose, other polysaccharide based polymers such as Chitosan and pectin, synthetic polymers like polyvinyl acetate, and the like. The polymer binders can be self-crosslinking upon exposure to radiation, and/or they can be crosslinked with a photoinitiator or other crosslinking agent. In some embodiments, photocrosslinkers may form radicals upon exposure to radiation, and the radicals then induce crosslinking reactions based on radical polymerization mechanisms. Suitable photoinitiators include, for example, commercially available products, such as IRGACURE® brand (BASF), GENOCURE™ brand (Rahn USA Corp.), and DOUBLECURE® brand (Double Bond Chemical Ind., Co, Ltd.), combinations thereof or the like. The hardcoat polymers can be used as a binder alone or in combination with another binder, such as a polysaccharide based binder. The hardcoat can be fused after completion of the curing process in some embodiments.

Wetting agents can be used to improve the coatability of the metal nanowire inks as well as the quality of the metal nanowire dispersion. In particular, the wetting agents can lower the surface energy of the ink so that the ink spreads well onto a surface following coating. Wetting agents can be surfactants and/or dispersants. Surfactants are a class of materials that function to lower surface energy, and surfactants can improve solubility of materials. Surfactants generally have a hydrophilic portion of the molecule and a hydrophobic portion of the molecule that contributes to its properties. A wide range of surfactants, such as nonionic surfactants, cationic surfactant, anionic surfactants, zwitterionic surfactants, are commercially available. In some embodiments, if properties associated with surfactants are not an issue, non-surfactant wetting agents, e.g., dispersants, are also known in the art and can be effective to improve the wetting ability of the inks. Suitable commercial wetting agents include, for example, COATOSIL™ brand epoxy functionalized silane oligomers (Momentum Performance Materials), SILWET™ brand organosilicone surfactant (Momentum Performance Materials), THETAWET™ brand short chain non-ionic fluorosurfactants (ICT Industries, Inc.), ZETASPERSE® brand polymeric dispersants (Air Products Inc.), SOLSPERSE® brand polymeric dispersants (Lubrizol), XOANONS WE-D545 surfactant (Anhui Xoanons Chemical Co., Ltd), EFKA™ PU 4009 polymeric dispersant (BASF), MASURF FP-815 CP, CAPSTONE® fluorosurfactants, such as FS-30 and FS-34, (DuPont), MASURF FS-910 (Mason Chemicals), NOVEC™ FC-4430 fluorinated surfactant (3M), mixtures thereof, and the like.

Thickeners can be used to improve the stability of the dispersion by reducing or eliminating settling of the solids from the metal nanowire inks. Thickeners may or may not significantly change the viscosity or other fluid properties of the ink. Suitable thickeners are commercially available and include, for example, CRAYVALLAC™ brand of modified urea such as LA-100 (Cray Valley Acrylics, USA), polyacrylamide, THIXOL™ 53 L brand acrylic thickener, COAPUR™ 2025, COAPUR™ 830 W, COAPUR™ 6050, COAPUR™ XS71 (Coatex, Inc.), BYK® brand of modified urea (BYK Additives), Acrysol DR 73, Acrysol RM-995, Acrysol RM-8W (Dow Coating Materials), Aquaflow NHS-300, Aquaflow XLS-530 hydrophobically modified polyether thickeners (Ashland Inc.), Borchi Gel L 75 N, Borchi Gel PW25 (OMG Borchers), and the like.

As noted above, the inks for depositing the sparse metal conductive layers can further comprise nanoscale fillers, as discussed above. In general, the solution to form the sparse metal conductive layer can comprise from about 0.0001 wt % to about 2.5 wt % nanoscale fillers, in further embodiments from about 0.0002 wt % to about 2 wt % and in additional embodiments from about 0.0005 to about 1.5 wt % nanoscale fillers. A person of ordinary skill in the art will recognize that additional ranges of nanoparticle concentrations within the explicit ranges above are contemplated and are within the present disclosure.

Additional additives can be added to the metal nanowire ink, generally each in an amount of no more than about 5 weight percent, in further embodiments no more than about 2 weight percent and in further embodiments no more than about 1 weight percent. Other additives can include, for example, anti-oxidants, UV stabilizers, defoamers or anti-foaming agents, anti-settling agents, viscosity modifying agents, or the like.

As noted above, fusing of the metal nanowires can be accomplished through various agents. Without wanting to be limited by theory, the fusing agents are believed to mobilize metal atoms, and the free energy seems to be lowered in the fusing process. Excessive metal migration or growth may lead in some embodiments to a degeneration of the optical properties, so desirable results can be achieved through a shift in equilibrium in a reasonably controlled way, generally for a short period of time, to generate sufficient fusing to obtain desired electrical conductivity while maintaining desired optical properties. In some embodiments, initiation of the fusing process can be controlled through a partial drying of the solutions to increase concentrations of the components, and quenching of the fusing process can be accomplished, for example, through rinsing or more completing drying of the metal layer. The fusing agent can be incorporated into a single ink along with the metal nanowires. The one ink solution can provide appropriate control of the fusing process.

In some embodiments, a process is used in which a sparse nanowire film is initially deposited and subsequent processing with or without depositing another ink provides for the fusing of the metal nanowires into a metal nanostructured network, which is electrically conducting. The fusing process can be performed with controlled exposure to a fusing vapor and/or through the deposition of a fusing agent in solution. Sparse metal conductive layers are generally formed on a selected substrate surface. The as-deposited nanowire film generally is dried to remove the solvent. Processing can be adapted for patterning of the film.

For the deposition of the metal nanowire ink, any reasonable deposition approach can be used, such as dip coating, spray coating, knife edge coating, bar coating, Meyer-rod coating, slot-die coating, gravure printing, spin coating or the like. The ink can have properties, such as viscosity, adjusted appropriately with additives for the desired deposition approach. Similarly, the deposition approach directs the amount of liquid deposited, and the concentration of the ink can be adjusted to provide the desired loading of metal nanowires on the surface. After forming the coating with the dispersion, the sparse metal conductive layer can be dried to remove the liquid.

The films can be dried, for example, with a heat gun, an oven, a thermal lamp or the like, although the films that can be air dried can be desired in some embodiments. In some embodiments, the films can be heated to temperatures from about 50° C. to about 150° C. during drying. After drying, the films can be washed one or more times, for example, with an alcohol or other solvent or solvent blend, such as ethanol or isopropyl alcohol, to remove excess solids to lower haze. Patterning can be achieved in several convenient ways. For example, printing of the metal nanowires can directly result in patterning. Additionally or alternatively, lithographic techniques and/or ablation methods can be used to remove portions of the metal nanowires, prior to or after fusing, to form a pattern. One or more overcoat layers can be applied over the sparse metal conductive layer, as described above.

Optically clear adhesive layers and thicker protective films covering the sparse metal conductive layer can be formed with holes or the like in appropriate locations to provide for electrical connections to the conductive layer. In general, various polymer film processing techniques and equipment can be used to the processing of these polymer sheets, and such equipment and techniques are well developed in the art, and future developed processing techniques and equipment can be correspondingly adapted for the materials herein.

### Coating and Curing of the Hardcoat

As noted above, the polymer precursor solutions are formulated with a mixture of polymer chemistries. The selected polymer precursors are mixed in a solvent, which may be a solvent blend, for processing into a coating. The coating precursor solution can be coated/printed as described below to obtain a desired wet coating. The wet coating is dried appropriately to form the dry coating. Then, the dried coating can be cured, generally with UV light, to form the cured polymer coating. Following curing, the film can be subjected to further processing.

For the deposition of the coating precursor solutions, any reasonable deposition approach can be used, such as dip coating, spray coating, knife edge coating, bar coating, Meyer-rod coating, slot-die coating, gravure coating or printing, spin coating or the like. In general, coating approaches form a uniform coating and printing approaches may form a pattern. The solution properties can be adjusted as appropriate for the coating approach. In particular, certain deposition approaches operate with certain fluid property ranges and the resulting wet coating thickness can be dependent on fluid properties, such as viscosity. Generally, the fluid properties can be adjusted through adjustment of residue concentration, solvent selection as well as potentially adding viscosity modifying additives. In some processing contexts, slot coating is a desirable approach for precursor solution deposition.

The deposition approach directs the amount of liquid deposited, and the concentration of the solution can be adjusted to provide the desired thickness of product coating on the surface. The residue concentrations along with the wet coating thickness determine the thickness of the dry coating. So the concentration of the coating solution and the wet coating thickness can be independently adjusted to achieve a desired dry coating thickness.

After forming the wet coating with the polymer precursor coating solution, the coating can be dried to remove the solvent liquid and crosslinked appropriately. The coatings can be dried, for example, with a heat gun, an oven, a thermal lamp or the like, although the films that can be air dried can be desired in some embodiments. In some embodiments, the films can be heated to temperatures from about 50° C. to about 150° C. during drying. A person of ordinary skill in the art will recognize that additional ranges of temperatures within the explicit ranges above are contemplated and are within the present disclosure.

The polymer component of the coating generally can be crosslinked with UV radiation with or without heat. UV radiation for curing the polymers generally has a wavelength consistent with the catalysts used. Correspondingly, a range of commercial UV curing systems for polymers are available to cure based on corresponding commercial catalysts. The UV curing system can deliver UV light energy, for example, from about 0.05 J/cm² to about 10 J/cm², in further embodiments from about 0.1 J/cm² to about 5 J/cm², and in additional embodiments from about 0.2 J/cm² to about 2 J/cm². A person of ordinary skill in the art will recognize that additional ranges of irradiation intensity within the explicit ranges above are contemplated and are within the present disclosure. Various commercial sources of UV curing systems based on mercury vapor bulbs or other suitable light source are available, such as Heraeus Noblelight America LLC (USA), Dymax Corporation (USA), and Komori Corporation (Japan). Pulsed light sources may also be used, such as the RC-Series Modulated UV Curing System from Xenon Corporation (Wilmington, Mass. USA). Coating systems generally use conventional UV bulbs with known UV spectral coverage. For example, H bulbs based on mercury cover UVA, UVB and UVC spectral ranges.

### Properties of the Hardcoat

The hardcoat provides some protection to the underlying material. The mechanical protection can be evaluated, for example, using pencil hardness and scratch resistance. Furthermore, with respect to protection of sparse metal conductive layers, accelerated wear testing can be performed to evaluate the protection provided by the hardcoat. Comparable testing can be performed with property enhancing fillers loaded into the hardcoat. The hardcoats described herein provide good protection to the underlying materials.

Hardness of the loaded polymer films can be measured with the pencil hardness test for films based on ASTM D3363. Following pencil sharpening methodology, a constant downward applied force is used while holding the pencil at a 45° angle. A Pencil hardness Kit can be used for the measurements with weights of 500 grams or 750 grams, or 1000 grams. Hardness can be determined by analyzing the effect of different pencils in the graphite grading scale. If no damage was done to the base layer, the film was considered to have passed. The film was checked under a Leica microscope at a 20× magnification or with the naked eye if damage is visible with the naked eye indicative of failure of the test. The hardness scales range with grade values from 9B to 9H, with higher values of B corresponding to lower values of hardness and larger values of H corresponding to increased hardness, and a value of F connects the B and H ranges and the lowest “B” value is HB followed by B, 2B, . . . , 9B. With the hardcoat materials described herein, the pencil hardness is observed to depend significantly on the properties of the substrate, but the hardcoats are found to have comparable pencil hardness as commercial hardcoats. In some embodiments, the coating with the property enhancing nanoparticles, such as nanodiamonds, can have a pencil hardness of at least one grade greater hardness, in some embodiments at least bout 2 grades greater, and in further embodiments at least about 3 grades greater pencil hardness relative to an equivalent coating in all other respects except without the property enhancing nanoparticles. Other scales and tests for hardness are available, and qualitatively similar trends should follow. Scratch resistance is also evaluated with the use of steel wool rubbed against the surface with a 100 g, 200 g, or 500 g weight, as described further in the Examples below. Superfine steel wool was used to scratch the film by rubbing the surface after the transparent overcoat is applied. As described further in the Examples, additional testing was performed with solvent rubbing, and a test of chemical resistance, adhesion testing and soaking in a solvent.

Solvent rub tests were performed on the coatings. The solvent rubs were guided by ASTM D5402 standard procedure for performing a solvent rub to evaluate coating resistance to damage. ASTM D-5402-06R11 “Standard Practice for Assessing the Solvent Resistance of Organic Coatings Using Solvent Rubs” is incorporated herein by reference. As described in the Examples, acetone or isopropyl alcohol were used in solvent rubs. The sample was deemed to pass the test following a specified number of double rubs with the solvent with no damage to the surface. Two types of adhesion tests were performed. In a first type of adhesion test, a piece of standard office tape, such as Scotch® tape, is applied to the coating and pealed back. If the coating is not visibly damaged and the sheet resistance of a sparse metal conductive layer is not changed by 20% or more, the coating is deemed to have passed the adhesion test. In a second cross hatched adhesion test, the coating is cut in a cross hatched pattern, and adhesion is determined on the cut surface as described in more detail in the Examples. The cross hatched adhesion test followed a standard procedure according to ASTM D3359.

In the context of sparse metal conductive layers, nanoscale colorants may be selected to lower the overall value of b* in the CIE color scale. Highly conductive sparse metal conductive layers composed of silver can be found to have a yellowish tint, and the lowering of b* can result in a whiter and more neutral appearance of the film. As demonstrated in the '400 application cited above, several specific nanoscale colorants have been found to successfully lower the b* value of transparent conductive films. Additionally or alternatively, a selected color or color pattern can be introduced through the incorporation of selected nanoscale colorants. For example, a pattern of colored panels can be introduced.

In some embodiments, the nanoscale colorant can result in a decrease in b* of at least about 0.2, in further embodiments at least about 0.25, and in additional embodiments at least about 0.3 relative to corresponding films without the nanoscale colorant. Also, it can be desirable for the absolute value of b* for the transparent film to be no more than 1.2, in further embodiments no more than 1.1 and in additional embodiments no more than a value of 1.0. For embodiments with desired more white transmission, the absolute value of a* in the films with the nanoscale colorants can be no more than about 1, in additional embodiment no more than about 0.75, in other embodiments no more than about 0.6, and in further embodiments no more than about 0.5. A person of ordinary skill in the art will recognize that additional ranges of optical parameters within the explicit ranges above are contemplated and are within the present disclosure. Values of b* and a* can be evaluated using the equations in the standard CIE DE2000, Center International Commission on Illumination (Commission Internationale de L'Eclairage), see Colorimetry, 3rd Edition, CIE, 2004, incorporated herein by reference. These calculations can be performed using commercial spectrophotometers and software, such as Konica Minolta Spectrophotometer CM-3700A with SpectraMagic™ NX software.

The transparent hardcoats with nanodiamond fillers in particular are able to achieve pencil hardness values of H or greater. These, coating have also been found to maintain a surprising degree of flexibility. Specifically, the nanodiamond loaded films have been tested under ASTM D522 Mandrel Bend Test, as described in the examples. In the test, samples are bent around mandrels with 1 mm, 2 mm, and 3 mm diameters by hand 50 times each. If there is no visible cracking at the end of the bending, the samples are examined under a light microscope. If no cracking was observed by visible inspection or under the microscope, then the sample was deemed to have passed.

The transparent coating with nanoscale colorants in some embodiments can cause a decrease of the total transmittance of visible light relative to a corresponding coating without the nanoscale colorants by no more than about 5 percentage points, in further embodiments no more than about 3 and in additional embodiments no more than about 1.5 percentage points. Also, the transparent coating with nanoscale colorants can cause an increase of the haze in some embodiments relative to corresponding unloaded coatings by no more than about 1.5 percentage points, in further embodiments by no more than about 1, and in additional embodiments by no more than about 0.6 percentage points. A person of ordinary skill in the art will recognize that additional ranges of modifications of optical properties due to loaded polymer coatings within the explicit ranges above are contemplated and are within the present disclosure.

### Transparent Film Electrical, Optical Properties and Stability

The fused metal nanostructured networks can provide low electrical resistance while providing good optical properties. Thus, the films can be useful as transparent conductive electrodes or the like. The transparent conductive electrodes can be suitable for a range of applications such as electrodes along light receiving surfaces of solar cells. For displays and in particular for touch screens, the films can be patterned to provide electrically conductive patterns formed by the film. The substrate with the patterned film, generally has good optical properties at the respective portions of the pattern.

Electrical resistance of thin films can be expressed as a sheet resistance, which is reported in units of ohms per square (Ω/□ or ohms/sq) to distinguish the values from bulk electrical resistance values according to parameters related to the measurement process. Sheet resistance of films is generally measured using a four point probe measurement or another suitable process. In some embodiments, the fused metal nanostructured networks can have a sheet resistance of no more than about 300 ohms/sq, in further embodiments no more than about 200 ohms/sq, in additional embodiments no more than about 100 ohms/sq and in other embodiments no more than about 60 ohms/sq. A person of ordinary skill in the art will recognize that additional ranges of sheet resistance within the explicit ranges above are contemplated and are within the present disclosure. Depending on the particular application, commercial specifications for sheet resistances for use in a device may not be necessarily directed to lower values of sheet resistance such as when additional cost may be involved, and current commercially relevant values may be for example, 270 ohms/sq, versus 150 ohms/sq, versus 100 ohms/sq, versus 50 ohms/sq, versus 40 ohms/sq, versus 30 ohms/sq, versus 20 ohms/sq or less as target values for different quality, touch response, and/or size touch screens, and each of these values defines a range between the specific values as end points of the range, such as 270 ohms/sq to 150 ohms/sq, 270 ohms/sq to 100 ohms/sq, 150 ohms/sq to 100 ohms/sq and the like with 15 particular ranges being defined. Thus, lower cost (i.e. lower materials cost per film area) films may be suitable for certain applications in exchange for modestly higher sheet resistance values. In general, sheet resistance can be reduced by increasing the loading of nanowires, but an increased loading may not be desirable from other perspectives, and metal loading is only one factor among many for achieving low values of sheet resistance.

For applications as transparent conductive films, it is desirable for the fused metal nanostructured networks to maintain good optical transparency. In principle, optical transparency is inversely related to the loading with higher loadings leading to a reduction in transparency, although processing of the network can also significantly affect the transparency. Also, polymer binders and other additives can be selected to maintain good optical transparency. The optical transparency can be evaluated relative to the transmitted light through the substrate. For example, the transparency of the conductive film described herein can be measured by using a UV-Visible spectrophotometer and measuring the total transmission through the conductive film and support substrate. Transmittance is the ratio of the transmitted light intensity (I) to the incident light intensity (Iₒ). The transmittance through the film (T_{film}) can be estimated by dividing the total transmittance (T) measured by the transmittance through the support substrate (T_{sub}). (T=I/Iₒ and T/T_{sub}=(I/Iₒ)/(I_{sub}/Iₒ)=I/I_{sub}=T_{film}) Thus, the reported total transmissions can be corrected to remove the transmission through the substrate to obtain transmissions of the film alone. While it is generally desirable to have good optical transparency across the visible spectrum, for convenience, optical transmission can be reported at 550 nm wavelength of light. Alternatively or additionally, transmission can be reported as total transmittance from 400 nm to 700 nm wavelength of light, and such results are reported in the Examples below. In general, for the fused metal nanowire films, the measurements of 550 nm transmittance and total transmittance from 400 nm to 700 nm (or just “total transmittance” for convenience) are not qualitatively different. In some embodiments, the film formed by the fused network has a total transmittance (TT %) of at least 80%, in further embodiments at least about 85%, in additional embodiments, at least about 90%, in other embodiments at least about 94% and in some embodiments from about 95% to about 99%. Transparency of the films on a transparent polymer substrate can be evaluated using the standard ASTM D1003 (“Standard Test Method for Haze and Luminous Transmittance of Transparent Plastics”), incorporated herein by reference. A person or ordinary skill in the art will recognize that additional ranges of transmittance within the explicit ranges above are contemplated and are within the present disclosure. When adjusting the measured optical properties for the films in the Examples below for the substrate, the films have very good transmission and haze values, which are achieved along with the low sheet resistances observed.

The fused metal networks can also have low haze along with high transmission of visible light while having desirably low sheet resistance. Haze can be measured using a hazemeter based on ASTM D1003 referenced above, and the haze contribution of the substrate can be removed to provide haze values of the transparent conductive film. In some embodiments, the sintered network film can have a haze value of no more than about 1.2%, in further embodiments no more than about 1.1%, in additional embodiments no more than about 1.0% and in other embodiments from about 0.9% to about 0.2%. As described in the Examples, with appropriately selected silver nanowires very low values of haze and sheet resistance have been simultaneously achieved. The loading can be adjusted to balance the sheet resistance and the haze values with very low haze values possible with still good sheet resistance values. Specifically, haze values of no more than 0.8%, and in further embodiments from about 0.4% to about 0.7%, can be achieved with values of sheet resistance of at least about 45 ohms/sq. Also, haze values of 0.7% to about 1.2%, and in some embodiments from about 0.5% to about 0.9%, can be achieved with sheet resistance values of from about 30 ohms/sq to about 45 ohms/sq. All of these films maintained good optical transparency. A person of ordinary skill in the art will recognize that additional ranges of haze within the explicit ranges above are contemplated and are within the present disclosure.

With respect to the corresponding properties of the multilayered films, the additional components are generally selected to have a small effect on the optical properties, and various coatings and substrates are commercially available for use in transparent elements. Suitable optical coatings, substrates and associated materials are summarized above. Some of the structural material can be electrically insulating, and if thicker insulating layers are used, the film can be patterned to provide locations where gaps or voids through the insulating layers can provide access and electrical contact to the otherwise embedded electrically conductive element.

### Transparent Electrically Conductive Film Stability and Stability Testing

In use, it is desirable for the transparent conductive films to last a commercially acceptable time, such as the lifetime of the corresponding device. The hardcoats evaluated in terms of their ability to stabilize a fused nanostructured metal network in terms of maintenance of the conductive properties of the sparse metal conductive layers are sufficiently maintained. To test the performance, accelerated aging procedures can be used to provide objective evaluation over a reasonable period of time. These tests can be performed using commercially available environmental test equipment.

One selected test, which is used in the Examples involves black standard temperature of 60° C. (a setting of the apparatus), an air temperature of 38° C., a relative humidity of 50% and an irradiance of 60 W/m² (300 nm to 400 nm) from xenon lamps with a daylight filter. In another test, the sample is exposed to 60° C. and 90% relative humidity without light exposure. Two further tests were performed with exposure to heat of either 85° C. or 150° C. without the further application of humidity or light. In the 150° C. test, the coated films are heated for 0.5 hr and the change in sheet resistance is evaluated. For the other tests, the change in sheet resistance is measured as times specified in the Examples. A variety of suitable test equipment is commercially available, such as Atlas Suntest™ XXL apparatus (Atlas Material Testing Solutions, Chicago, Ill., USA) and a SUGA environmental test instrument, Super Xenon Weather Meter, SX75 (SUGA Test Instruments Co., Limited, Japan).

Under the test conditions specified in the previous paragraph, a sample can be evaluated by the change in sheet resistance as a function of time. The values can be normalized to the initial sheet resistance to focus on the time evolution. So generally the time evolution is plotted for Rₜ/R₀, where Rₜ is the time evolving sheet resistance measurement and R₀ is the initial value of sheet resistance. In some embodiments, the value of Rₜ/R₀ can be no more than a value of 1.8 and no less than a value of 0.5 after 1000 hour, in further embodiments no more than a value of 1.6 and in additional embodiment no more than a value of 1.4 and no less than a value of 0.7 after 1000 hours of environmental testing. From another perspective, the value of Rₜ/R₀ can be no more than a value of 1.5 and no less than 0.5 after about 1000 hours. In some embodiments, the value of Rₜ/R₀ may not increase more than about 20% after 300 hours when subjected to light irradiance of 60 W/m² (300 nm-400 nm) at a temperature of 60° C. and a relative humidity of 50%. A person of ordinary skill in the art will recognize that additional ranges of Rₜ/R₀ and stability times within the explicit ranges above are contemplated and are within the present disclosure.

### Touch Sensors

The transparent conductive films described herein can be effectively incorporated into touch sensors that can be adapted for touch screens used for many electronic devices. Some representative embodiments are generally described here, but the transparent conductive films can be adapted for other desired designs. A common feature of the touch sensors generally is the presence of two transparent conductive electrode structures in a spaced apart configuration in a natural state, i.e., when not being touched or otherwise externally contacted. For sensors operating based on capacitance, a dielectric layer is generally between the two electrode structures. Referring to FIG. 3, a representative capacitance based touch sensor 202 comprises a display component 204, an optional bottom substrate 206, a first transparent conductive electrode structure 208, a dielectric layer 210, such as a polymer or glass sheet, a second transparent conductive electrode structure 212, optional top cover 214, and measurement circuit 216 that measures capacitance changes associated with touching of the sensor. Referring to FIG. 4, a representative resistance based touch sensor 240 comprises a display component 242, an optional lower substrate 244, a first transparent conductive electrode structure 246, a second transparent conductive electrode structure 248, support structures 250, 252 that support the spaced apart configuration of the electrode structures in their natural configuration, upper cover layer 254 and resistance measuring circuit 256. Alternatively the sensors can be composed of one single film with two layers of transparent conductors—one on each surface with the substrate (plastic or glass) which serves as both the support and as the dielectric layer. Sensor can also be composed of a single layer of transparent conductive material where more precise patterning and processing are required to spatially separate the “X” and “Y” conductive elements.

Display components 204, 242 can be, for example, LED based displays, LCD displays or other desired display components. Substrates 206, 244 and cover layers 214, 254 can be independently transparent polymer sheets or other transparent sheets. Support structures can be formed from a dielectric material, and the sensor structures can comprise additional supports to provide a desired stable device. Measurement circuits 216, 256 are known in the art.

Transparent conductive electrodes 208, 212, 246 and 248 can be effectively formed using fused metal networks, which can be patterned appropriately to form distinct sensors, although in some embodiments the fused metal networks form some transparent electrode structures while other transparent electrode structures in the device can comprise materials such as electrically conductive metal oxides, for example indium tin oxide, aluminum doped zinc oxide, indium doped cadmium oxide, fluorine doped tin oxide, antimony doped tin oxide, or the like as thin films or particulates, carbon nanotubes, graphene, conductive organic compositions or the like. Fused metal networks can be effectively patterned as described herein, and it can be desirable for patterned films in one or more of the electrode structures to form the sensors such that the plurality of electrodes in a transparent conductive structure can be used to provide position information related to the touching process. The use of patterned transparent conductive electrodes for the formation of patterned touch sensors is described, for example, in U.S. Pat. No. 8,031,180 to Miyamoto et al., entitled “Touch Sensor, Display With Touch Sensor, and Method for Generating Position Data,” published U.S. patent application 2012/0073947 to Sakata et al., entitled “Narrow Frame Touch Input Sheet, Manufacturing Method of Same, and Conductive Sheet Used in Narrow Frame Touch Input Sheet,” and U.S. Pat. No. 8,482,541B2 to Hashimoto et al., entitled “Touch Panel and Portable Device Using the Same,” all three of which are incorporated herein by reference.

### EXAMPLES

The following examples involve the coating of polymer precursor solutions onto polymer films. In some experiments, the hardcoats are placed on fused metal nanostructured layers on a polyethylene terephthalate (PET) polyester substrate. Some examples involved loading the overcoat precursor solution with nanodiamonds before coating onto the polymer film. Following drying and curing, the coated films are tested with respect to various optical properties, hardness, abrasion resistance, chemical resistance and/or stability of the conductive layer.

Commercial silver nanowires were used in the following examples with an average diameter of between 20 and 50 nm and an average length of 10-30 microns. The silver nanowire ink was essentially as described in Example 5 of copending U.S. patent application Ser. No. 14/448,504 to Li et al., entitled “Metal Nanowire Inks for the Formation of Transparent Conductive Films with Fused Networks,” incorporated herein by reference. The metal nanowire ink comprised silver nanowires at a level between 0.1 to 1.0 wt %, between 0.05 mg/mL and 2.5 mg/mL silver ions, and a cellulose based binder at concentrations from about 0.01 to 1 wt %. The silver nanowire inks were aqueous solutions with a small amount of alcohol. The ink was slot coated onto a PET polyester film. After coating the nanowire inks, the films were then heated in an oven at 100° C. for 10 min to dry the films, which also results in fusing of the nanowires into a network.

The total transmission (TT) and haze of the AgNWs film samples were measured using a Haze Meter with films on a polymer substrate. To adjust the haze measurements for the samples below, a value of substrate haze can be subtracted from the measurements to get approximate haze measurements for the transparent conductive films alone. The instrument is designed to evaluate optical properties based on ASTM D 1003 standard (“Standard Test Method for Haze and Luminous Transmittance of Transparent Plastics”), incorporated herein by reference. The total transmission and haze of the bare commercial polymer film substrates are provided in the Examples below. CIELAB values of b* were determined using commercial software from measurements made with a Konica Minolta Spectrophotometer CM-3700A with SpectraMagic™ NX software.

The pencil hardness of the AgNW film samples were measured using a Pencil Test. Pencils were prepared following the pencil sharpening methodology, abrasive paper use for pencil tip modification, and a constant downward applied force was applied while holding the pencil at a 45° angle on the test film. This test uses a 500 g—B—2084 Pencil hardness kit. The instrument is designed to evaluate optical properties based on ASTM D3363 standard, incorporated herein by reference. Hardness was determined by analyzing the effect of different pencils in the graphite grading scale on the base conductive layer. If no damage was done to the base layer, the film was considered to have passed that specific graphite level. The film was checked under a Leica microscope at a 20× magnification. If scratches were visible with the naked eye, verification under the microscope may not have been performed since the visible observation would already indicate the result. The flatness of the surface the film was verified before performing the scratching by the pencil as the films are very thin.

In the steel wool analysis, super fine steel wool was used to scratch the film (by rubbing the surface) after the overcoat or hardcoat was applied. Steel wool rub was performed very gently, while keeping a constant downward force. A section of the film under test was subject to the test, with the wool rubbed 5 times (5×) back and forth. The film sample is then observed for visible scratches, and the number of scratches made are indicated in the results section.

Solvent double rubbing tests were performed according to ASTM standard D-5402. A specified number of double rubs were performed with a specified solvent, and the coating was examined for damage. Damage was evaluated in terms of either visible change to the film or an increase in sheet resistance. Isopropyl alcohol double rubbing tests were generally performed with 50 double rubs, and for acetone, a test was performed generally with either 10 or 20 double rubs to determine if the test was passed. A chemical test was performed on some samples in which separate film samples were soaked in acetone, ethanol, toluene, acid or base for 5 minutes. In the chemical test, the acid was a 5% HCl solution, and the base was a 5% NaOH solution. If the sheet resistance did not change by more than 20% (R/R₀<1.2), then the samples were indicated as passing the soak test.

In the Light Fade Test, the film samples were exposed to light at elevated irradiance, temperature and relative humidity of 60 W/m² (300 nm-400 nm), 60° C. and 50% respectively in an Atlas SUNTEST™ XXL+ apparatus. Experiments were performed on either the coated films or on a stack with additional layers added over the overcoat layer. For the stack embodiments, an optically clear adhesive layer and an additional PET film was laminated onto both surfaces of the film. The lower surface of the stack, relative to the overcoat layer, was half covered with black tape. Such a test configuration is similar to that used in published U.S. patent application 2015/0090573 to Mansky et al., entitled “Silver Nanostructure-Based Optical Stacks and Touch Sensors With UV Protection,” incorporated herein by reference. A stack in the test apparatus has the following orientation: Xenon LAMP shining onto the Black Tape (covering half of the surface). The results are shown as the change in film conductivity as the ratio of final sheet resistance to initial sheet resistance (R/R₀) after a specific UV exposure time.

Three additional tests were performed in the testing apparatus. In one test, the temperature was set at 60° C. at a relative humidity of 90% without illumination. This test is referred to as the 60/90 test. A further test was performed at 85° C. with no controlled humidity or illumination. This test is referred to as the 85 C test. A third test was performed at 150° C. for a half an hour without added humidity or light, which is referred to as the 150 C test. For the 60/90 test, the 85 C test and the 150 C test, the change in film conductivity is presented as a ratio of final sheet resistance to initial sheet resistance (R/R₀) after the amount of time specified in the table.

A rubbing test was performed with a cotton swab in which the cotton swab was rubbed on the film surface several times back and forth with moderate force. If there is no damage to the base film or marks on the surface after rubbing with the cotton swab, then it means the hardcoat film is well cured. A regular adhesion test was performed by applying conventional office tape on the film surface, pulling off the tape from the surface three times, measure the sheet resistance change. The sample was given a pass on the adhesion test if the sheet resistance change was less than 20%. For crosshatch adhesion test which is ASTM standard test D3359, a crosshatch pattern is made though the film to the substrate. Detached flakes of coating are removed by brushing with a soft brush. Pressure-sensitive tape is applied over the crosshatch cut. Tape is smoothed into place by using a pencil eraser over the area of the incisions. Tape is removed by pulling it off rapidly back over itself as close to an angle of 180°. Adhesion is assessed on a 0 to 5 scale, with 5 corresponding to the best performance. If the missing part in the cross cut section is 0%, the score is 5. If the missing part of the cross cut section is less than 5%, the score is 4; if the missing part is 5-15%, the score is 3; if the missing part is 15-35%, the score is 2 if the missing part is 35-65%, the score is 1; and if the missing part of the crosscut section is more than 65%, the score is 0.

Two samples loaded with nanodiamonds were tested with a bending test following ASTM D522 Mandrel Bending Test as described above.

Table 1 provides the composition of three formulated coating solutions (labeled HOC1, HOC2 and HOC3) in term of relative weights of the ingredients. HOC2 is the modified version of HOC1 with improved hardness and solvent wiping resistance. The formulated coating materials comprised blends of commercial UV crosslinkable acrylate monomers with an aliphatic epoxy and a cyclic-siloxane epoxy resin. Two of the three precursor solutions further comprised a multifunctional urethane acrylate. The precursors comprise appropriate UV polymerization initiators. The solutions in Table 1 can be considered in the context of the examples as stock solutions, which may or may not be further diluted prior to coating. The stock solutions were diluted with additional solvents based on a final solid weight percent of the diluted solutions to obtain the data in some of the following Examples to facilitate formation of thinner dried coatings with the desired slot coating process to form the coatings of the Examples.

TABLE 1

| Composition | HOC1 | HOC2 | HOC3 |
|---|---|---|---|
| Dipentaerythritol hexaacrylate | 2 | 2 | — |
| Urethane acrylate (DM588) | 8 | 8 | — |
| Dipentaerythritol pentaacrylate | 2 | 2 | 8 |
| Trimethylolpropane triacrylate | 4 | 4 | 4 |
| 1,6 hexanediol diacrylate | 3 | 3 | — |
| Irgacure 500 | 0.8 | 0.5 | 0.24 |
| Irgacure TPO | — | 0.5 | — |
| Glycidyl POSS ® cage mixture | 2.5 | 2.5 | 2.5 |
| Diglycidyl ether of brominated neopentyl | 1.0 | 1.0 | 5.0 |
| glycol | | | |
| Propylene glycol monomethyl ether (PGME) | 24.1 | 26.6 | 8 |
| Diaryliodonium hexafluoroantimonate | 0.8 | 0.8 | 0.8 |
| Isopropyl alcohol | — | — | 11.5 |
| Total | 48.3 | 50.9 | 40.04 |

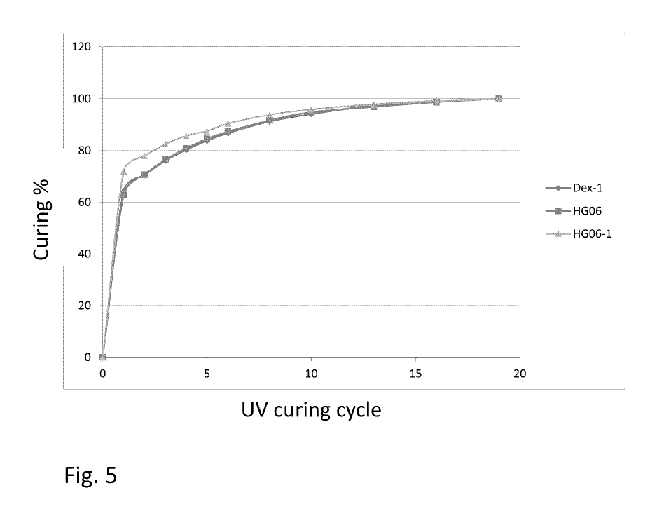

FIG. 5 shows that HOC1 has the same curing percentage as a commercial hardcoat from Dexerials, Inc. (Dex-1) at the every UV curing cycle, and HOC2 has the higher curing percentage than Dex-1 just after the first UV curing cycle. This result indicates that HOC1 and HOC2 have a comparable curing speed as Dex-1 or even faster than Dex-1.

### Example 1

### Hardcoats on Polymer Substrate—Comparison with Commercial Hardcoats

This example compares the pencil hardness of the newly formulated hardcoats in comparison with commercial hardcoats on bare polymer substrates.

The coatings were formed as described above and were cured at an energy of at 1.0 J/cm² with Heraeus DRS10/12QN Fusion UV System. Table 3 compares several commercial transparent hardcoat's hardness where each has an average dry thickness of 4-9 microns. The newly formulated hardcoats described herein had comparable hardness as the commercial hardcoats on the bare polymer substrates. Also, pencil hardness was evaluated with nanodiamonds (ND) loaded into the hardcoat. The hardcoats loaded with the nanodiamonds at roughly 0.01-0.5 wt % had significantly increased pencil hardness.

TABLE 3

| Manufacturer | Hardness |
|---|---|
| Kriya Materials (Netherlands) | 3H on PET |
| Dymax (CT, USA) | 3H on PET |
| Addison Clear Wave (IL, USA) | 5H on PET |
| Dexerials (Japan) | 3H on PET |
| HOC1 | 3-4H on PET |
| HOC1 + nanodiamonds | 8-9H on 125 μm PET |

### Example 2

### Performance and Comparison of Formulated Hardcoats and Commercial Hardcoats on Transparent Conductive Films

In this example, the performance of formulated overcoats and commercial overcoats are examined on a film over a fused metal nanostructured conductive network.

The substrate was prepared with a fused metal conductive layer as described above. The substrate with the conductive layer had an initial haze of 0.72%, an initial TT % of about 91% and a sheet resistance of about 50 ohms/sq. The hardcoat precursor solutions were diluted to yield a target dry coating thickness and were deposited onto the substrate by slot coating at 1 mil (25.4 microns) wet thickness. The films were then dried with a heat gun and cured with UV light under nitrogen using Heraeus DRS10/12QN Fusion UV System at 60% power with speed of 25 ft/min. The solid content of the coating solution correlates with the thickness of the dried film, and the films formed with coating solutions as specified in Table 1 had an average estimated thickness of about 187 nm.

A first set of samples were prepared using two formulated coating solutions (HOC1 and HOC2). Three samples were prepared, one with HOC2 and one with HOC1 both cured under at 1 J/cm² and one sample with HOC1 cured under 0.65 J/cm². For accelerated wear testing, the samples were placed into the testing apparatus with the hardcoat layer facing upward, as described above in the introductory section of the examples. Hardness, optical properties and solvent wiping resistance were compared between the films. The results are shown in Table 4. In general, HOC1 had greater hardness and the films exhibited comparable stability for the conductive layer.

TABLE 4

| | Sample | | HOC1 | HOC2 | HOC1 |
|---|---|---|---|---|---|
| Energy Curing (J/cm²) | | | 1.0 | 1.0 | 0.65 |
| Haze % | | | 0.91 | 0.93 | 0.88 |
| TT % | | | 91.3% | 91.3% | 91.7% |
| b* | | | 1.36 | 1.48 | 1.55 |
| Pencil Hardness | | | 4B | 2B | — |
| | Acetone | 20 | 1.04 | 1.06 | — |
| | Double | times | | | |
| | rubbing | 50 | 1.52 | 1.13 | — |
| | (R/R₀) | times | | | |
| | IPA Double | 20 | 1.00 | 0.98 | — |
| | rubbing | times | | | |
| | (R/R₀) | 50 | 1.00 | 1.02 | — |
| | | times | | | |

| | | | |
|---|---|---|---|
| Acetone Wipe | — | — | Pass |
| Chemical Test | Pass | Pass | — |
| 150° C. (R/R₀) | 1.08 | 1.12 | — |
| Light Fade (R/R₀) | 1140 hr | 240 hr | 660 hr |
| | 1.17 | 1.09 | 1.05 |
| 85° C. (R/R₀) | 12 days | 11 days | 10 days |
| | 1.17 | 1.15 | 1.18 |
| 60/90 (R/R₀) | 12 days | 20 days | 10 days |
| | 0.91/ | 1.15 | 1.10/ |
| | 21 days | | 17 days |
| | 1.01 | | 1.13 |

A second set of five samples were prepared using three formulated coating solutions (HOC1, HOC2 and HOC3), and a commercial overcoat from Dexerials (Dex-1). Solvent wiping resistance, high temperature resistance, light stability, hardness and surface tension were compared. The surface tension was measured with a Dyne Pen, and low surface tension values raise concerns about adhesion of other materials and layer to the surface. The results are shown in Table 5. HOC1 and HOC2 could be cured under significantly lower curing energy than HOC3. All of the samples resulted in a small reduction in haze. In general, HOC1 exhibited the most consistent stability results across all of the stability tests, and it exhibited the second highest hardness value.

TABLE 5

| Sample | | HOC1 | HOC2 | HOC3 | DEX-1 |
|---|---|---|---|---|---|
| Energy Curing (J/cm²) | | 0.65-1.0 | 0.65-1.0 | >1.3 | 0.55-1.0 |
| Haze Reduction (%) | | 0.1-0.2 | 0.1-0.2 | 0.1-0.2 | 0.1-0.2 |
| Solvent | IPA | Pass 50 | Pass 50 | Cannot | Pass 50 |
| wiping | wiping | times | times | pass | times |
| resistance | Acetone | Pass 20 | Pass 50 | — | Pass 50 |
| | wiping | times | times | | times |
| Solvent/acid/base | | Pass | Pass | Pass | Pass |
| soaking test | | | | | |
| High temperature | | Pass | Pass | Pass | Pass |
| resistance | | | | | |
| Durability | 85° C. | Pass for | Pass for | Fail | Pass for |
| | | more | more | | more |
| | | than 10 | than 10 | | than 10 |
| | | days | days | | days |
| | 60 C./ | Pass for | Pass for | Pass | Pass for |
| | 90RH | more | more | | more |
| | | than 10 | than 10 | | than 10 |
| | | days | days | | days |
| Light | Stack | >1000 hr | >300 hr | >1500 hr | >1000 hr |
| stability | level | | | | |
| | Film | >300 hr | >240 hr | 50 hr | Fail |
| | level | | | | before |
| | | | | | 80 hr |

| | | | | |
|---|---|---|---|---|
| Pencil Hardness | 4B | 2B | <5B | HB |
| Surface Tension (dyne) | 30-31 | 30-31 | — | <30 |

### Example 3

### Performance of Thicker HOC1 Hardcoat (2-10 μm) on Polymer Film Substrate

This example tests the performance of a thicker formulated hardcoat at various thickness (˜1-10 μm) on three polymer substrates.

A first set of samples was prepared on a commercial 125 micron thick PET transparent film having a hardcoat on one side of the PET layer (GS01) in which the test hardcoat is applied to the other side of the film. A second set of samples were prepared on a commercial 50 micron thick PET film (Kimoto) having hardcoats on both sides of the film (G1SBF), in which the test hardcoat is applied on one side of the film. A third set of samples was prepared on a commercial 50 micron thick film (MSK) having a hardcoat on both sides of the film, in which the test hardcoat is applied on one surface. For each substrate, three samples were formed using a formulated overcoat HOC1 at concentrations of 10%, 20% and 50% by weight, slot coated to an estimated dry thickness of 2 microns, 5 microns and 10 microns, respectively. The coating was dried and crosslinked with UV light. The three samples were compared against the control sample, which does not have the HOC1 overcoat. The results are presented in Table 6. In general, inclusion of the HOC1 overcoat results in a significant increase in hardness along with an improvement in transparency and a decrease in haze. An increase in thickness corresponding to 50 wt % HOC1 and 10 micron deposition did not measurably improve mechanical performance and resulted in a significant increase in haze.

TABLE 6

| | TT | Haze | Adhesion Test | Steel Wool Test | Pencil |
|---|---|---|---|---|---|
| Sample | % | % | (Crosshatch) | (5 times by hand) | Hardness |
| Control | 90.6 | 0.87 | — | — | <9B |
| 10% | 92.5 | 0.20 | 25/25 | No visible | 3H |
| HOC1 | | | | scratches | |
| (2 μm) | | | | | |
| 20% | 92.5 | 0.24 | 25/25 | No visible | 4H |
| HOC1 | | | | scratches | |
| (5 μm) | | | | | |
| 50% | 90.7 | 1.08 | 25/25 | No visible | 4H |
| HOC1 | | | | scratches | |
| (10 μm) | | | | | |

A second set of samples was prepared on a commercial 50-micron thick transparent film (G1SBF). Three samples were formed using a formulated overcoat HOC1 at concentrations of 10%, 20% and 50% by weight, slot coated to an estimated dry thickness of 2 microns, 5 microns and 10 microns, respectively. The coating was dried and crosslinked with UV light. The three samples were compared against the control sample, which does not have the HOC1 overcoat. The results are presented in Table 7. In general, inclusion of the HOC1 overcoat results in a moderate increase in haze, a slight increase in b*, and a slight increase in pencil hardness.

TABLE 7

| | TT | Haze | Adhesion Test | Steel Wool Test | Pencil |
|---|---|---|---|---|---|
| Sample | % | % | (Crosshatch) | (5 times by hand) | Hardness |
| Control | 92.6 | 0.11 | — | — | 2H |
| 10% | 92.5 | 0.17 | 25/25 | No visible | 2H |
| HOC1 | | | | scratches | |
| (2 μm) | | | | | |
| 20% | 92.6 | 0.21 | 25/25 | No visible | 3H |
| HOC1 | | | | scratches | |
| (5 μm) | | | | | |
| 50% | 92.6 | 0.35 | 25/25 | No visible | 3H |
| HOC1 | | | | scratches | |
| (10 μm) | | | | | |

A third set of samples was prepared on a commercial PET transparent film (MSK) Three samples were formed using a formulated overcoat HOC1 at concentrations of 10%, 20% and 50% by weight, slot coated to an estimated dry thickness of 2 microns, 5 microns and 10 microns, respectively. The coating was dried and crosslinked with UV light. The three samples were compared against the control sample, which does not have the HOC1 overcoat. The results are presented in Table 8. In general, inclusion of the HOC1 overcoat results in little change in optical properties. The thicker samples did not exhibit measurable changes in mechanical properties.

TABLE 8

| | TT | Haze | Adhesion Test | Steel Wool Test | Pencil |
|---|---|---|---|---|---|
| Sample | % | % | (Crosshatch) | (5 times by hand) | Hardness |
| Control | 92.5 | 0.20 | — | — | 2H |
| 10% | 92.5 | 0.28 | 25/25 | No visible | 3H |
| HOC1 | | | | scratches | |
| (2 μm) | | | | | |
| 20% | 92.5 | 0.23 | 25/25 | No visible | 3H |
| HOC1 | | | | scratches | |
| (5 μm) | | | | | |
| 50% | 92.4 | 0.31 | 25/25 | No visible | 3H |
| HOC1 | | | | scratches | |
| (10 μm) | | | | | |

### Example 4

### Performance of Thin HOC1 Hardcoat on Different PET Substrates

This example tests the performance of a thin formulated overcoat on three PET films. Three samples were formed on three substrates: (1) GS01, (2) G1SBF, and (3) MSK. The samples use a formulated overcoat HOC1 at a concentrations of 0.5 wt %, slot coated to an estimated dry thickness of 100 nm. Samples 2 and 3 made with G1SBF and MSK were first coated with a dummy ink that comprises the polymer binder and other components of the metal nanowire inks except that the metal nanowires were not included. The coatings after overcoat solution application were dried and crosslinked with UV light exposure. The results are presented in Table 9. In general, the overcoats were significantly softer in a pencil test compared with the thicker coatings of Example 3, and the coatings performed poorly in the steel wool test. The presence of the dummy ink coating did not alter the poor hardness performance.

TABLE 9

| | TT | Haze | Adhesion Test | Steel Wool Test | Pencil |
|---|---|---|---|---|---|
| Substrate | % | % | (Crosshatch) | (5 times by hand) | Hardness |
| GS01 | 92.4 | 0.77 | 25/25 | Many Scratches | <9B |
| G1SBF | 92.9 | 0.18 | 25/25 | Many Scratches | <9B |
| MSK | 92.9 | 0.25 | 25/25 | Many Scratches | <9B |

### Example 5

### Performance of HOC1 Hardcoat (2-5 μm Wet Thickness) with Nanodiamond on Polymer Film Substrate

This example tests the performance of a polymer hardcoat with nanodiamonds on three transparent polymer films.

On each transparent polymer films, experiments were performed with two samples. One sample (Sample 1) used HOC1 overcoat at 10 wt % solids concentration (diluted from the starting composition in Table 1 with a solvent mixture of PGME:DMA (Propylene glycol monomethyl ether: Dimethylacetamide) and loaded nanodiamond (0.01 wt %-0.8 wt % relative to organic solids), slot coated to an estimated dry thickness of 2 microns. A second sample (Sample 2) used HOC1 overcoat at 20 wt % solids concentration (formed by diluting the starting solution formulated as indicated in Table 1 with solvent mixture of PGME:DMA) loaded with nanodiamonds, slot coated to an estimated dry thickness of 5 microns. The nanodiamonds used were a commercial 3 wt % dispersion of hydrogenated nanodiamond. The coatings were dried and cured with UV light. Experiments were compared against a control sample, which contains no hardcoat or nanodiamonds.

The first transparent conductive film was formed on a commercial single-side hard-coated PET transparent film (GS01) by coating on the non-hardcoated side. The results are presented in Table 10. In general, inclusion of nanodiamond in HOC1 hardcoat on GS01 resulted in greater hardness and resistance to scratching. The thicker hardcoats exhibited greater pencil hardness even though they had lower concentrations of nanodiamonds.

TABLE 10

| | TT | Haze | Adhesion Test | Steel Wool Test | Pencil |
|---|---|---|---|---|---|
| Samples | % | % | (Crosshatch) | (5 times by hand) | Hardness |
| Control | 91.0 | 0.60 | — | — | — |
| 1 | 92.3 | 0.59 | 25/25 | No scratches | 8H |
| 2 | 92.3 | 0.53 | 20/25 | No scratches | 9H |

The second transparent conductive film was formed on a commercial double-side hard-coated PET transparent film (MSK). The results are presented in Table 11. Again, the thicker hardcoats exhibited greater pencil hardness and scratch resistance relative to the thinner hardcoats.

TABLE 11

| | TT | Haze | Adhesion Test | Steel Wool Test | Pencil |
|---|---|---|---|---|---|
| Sample | % | % | (Crosshatch) | (5 times by hand) | Hardness |
| Control | 92.7 | 0.15 | — | — | — |
| 1 | 92.8 | 0.56 | 25/25 | Some scratches | 2H |
| 2 | 92.7 | 0.45 | 25/25 | No scratches | 8H |

The third set of transparent conductive films was formed on a commercial polycarbonate transparent substrate. The results are presented in Table 12. The samples on the polycarbonate substrate had significantly lower pencil hardness and scratch resistance relative to the PET substrates reported above. Again, the thicker hardcoat has significantly increased pencil hardness and scratch resistance relative to the thinner hardcoat.

TABLE 12

| | TT | Haze | Adhesion Test | Steel Wool Test | Pencil |
|---|---|---|---|---|---|
| Sample | % | % | (Crosshatch) | (5 times by hand) | Hardness |
| Control | 92.5 | 0.06 | — | — | — |
| 1 | 93.1 | 1.43 | 25/25 | Many scratches | 8B |
| 2 | 92.9 | 2.15 | 25/25 | Some scratches | 3H |

### Example 6

### Performance of Hardcoats with or without Nanodiamonds Over a Range of Thicknesses

This Example provides performance results on two PET substrates with or without nanodiamond fillers and for varying thicknesses. The results further provide evidence of flexibility of the nanodiamond filled hardcoats.

Nine samples were prepared for processing on a first PET substrate (thirty micron thickness, Toray Lumirror®60 PET film) with a selected hardcoat thickness and a curing energy of 450 mJ/cm²). Seven samples included nanodiamonds at a selected concentration (0.01 wt %-0.8 wt % relative to organic solids), and two samples included a dummy ink coating with the components of the nanowire inks described above except for no nanowires. The results are presented in Table 13.

TABLE 13

| | | | | | | Steel | |
|---|---|---|---|---|---|---|---|
| | | | | | | Wool | |
| | | | | | Adhesion | Test | |
| | Dry | Nano- | | | Test | (5 times | Pencil |
| Sample | Thickness | diamond | TT % | Haze % | (Crosshatch) | by hand) | Hardness |
| Bare | | | 89.5 | 0.77 | | Badly | |
| PET | | | | | | scratched | |
| 1 | 100 nm | Yes | 90.9 | 0.31 | 20/20 | Badly | F |
| | | | | | | Scratched | |
| 2 | 250 nm | Yes | 91.7 | 1.31 | 20/20 | Badly | HB |
| | | | | | | scratched | |
| 3 | 500 nm | Yes | 91.1 | 0.46 | 20/20 | Some | HB |
| | | | | | | scratches | |
| 4* | 1000 nm | Yes | 91.0 | 0.51 | 20/20 | A couple | 2H |
| | | | | | | of | |
| | | | | | | scratches | |
| 5* | 2000 nm | Yes | 90.8 | 0.71 | 20/20 | No | 3H |
| | | | | | | scratches | |
| 6 | 250 nm | Yes | 90.2 | 0.71 | 20/20 | Badly | HB |
| | on | | | | | Scratched | |
| | dummy | | | | | | |
| | ink | | | | | | |
| 7 | 2000 nm | Yes | 90.6 | 0.13 | 20/20 | No | 3H |
| | on | | | | | Scratches | |
| | dummy | | | | | | |
| | ink | | | | | | |
| 8 | 250 nm | No | 91.5 | 1.31 | 20/20 | Badly | 2B |
| | | | | | | Scratched | |
| 9 | 1000 nm | No | 90.9 | 0.88 | 20/20 | One Fine | HB |
| | | | | | | Scratch | |

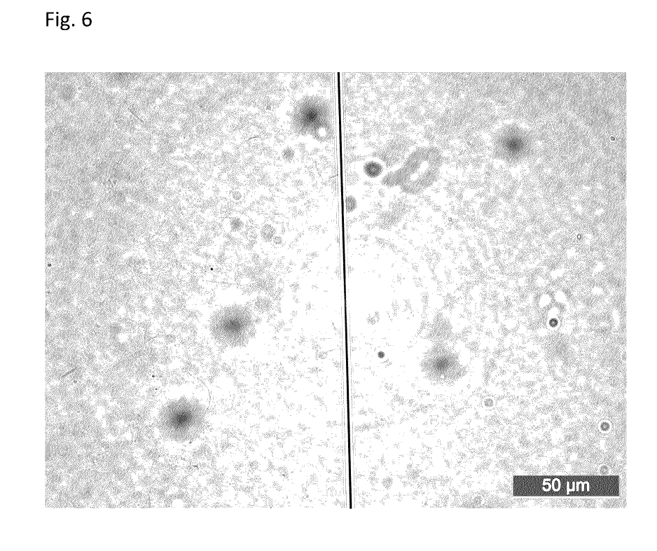

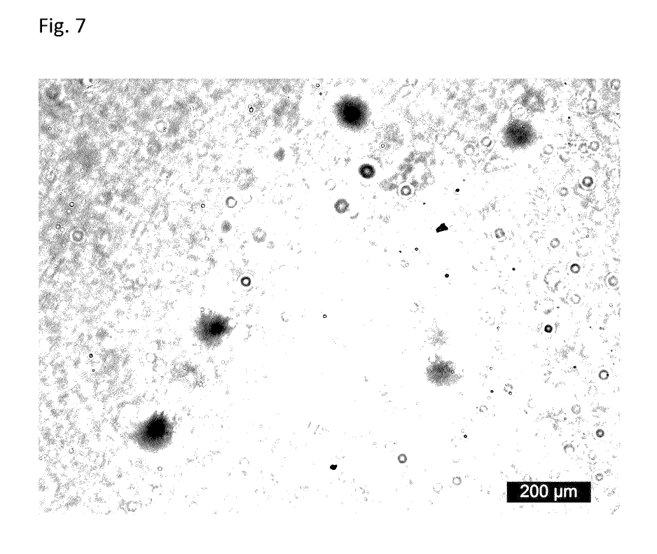

*The samples marked with * were also subjected to bending test, as described above. Both samples passed the test with no cracking. For comparison, a sample was also prepared with a commercial hardcoat, which exhibited cracking following the bending test. A representative cracked sample is shown in FIG. 6. A photograph of a representative sample similar to samples 4 and 5 in the Table above is shown in FIG. 7 following the bending test free of cracks.

Seven additional samples were prepared similar to the samples prepared above in this example except that a curing energy of 1 J/cm² was used. The properties of the resulting hardcoats are presented in Table 14.

TABLE 14

| | | | | | | Steel | |
|---|---|---|---|---|---|---|---|
| | | | | | | Wool | |
| | | | | | Adhesion | Test | |
| | Dry | Nano- | | | Test | (5 times | Pencil |
| Sample | Thickness | diamond | TT % | Haze % | (Crosshatch) | by hand) | Hardness |
| Bare | | | 89.5 | 0.77 | | Badly | |
| PET | | | | | | scratched | |
| 1 | 100 nm | Yes | 90.8 | 0.34 | 20/20 | Badly | HB |
| | | | | | | Scratched | |
| 2 | 250 nm | Yes | 91.8 | 1.13 | 20/20 | Badly | F |
| | | | | | | scratched | |
| 3 | 500 nm | Yes | 90.8 | 1.17 | 20/20 | Few | H |
| | | | | | | scratches | |
| 4 | 1000 nm | Yes | 90.8 | 0.59 | 20/20 | Few | H |
| | | | | | | scratches | |
| 5 | 2000 nm | Yes | 90.7 | 0.74 | 20/20 | One Fine | 3H |
| | | | | | | scratch | |
| 6 | 250 nm | No | 91.7 | 1.32 | 20/20 | Badly | HB |
| | | | | | | Scratched | |
| 7 | 1000 nm | No | 90.8 | 0.42 | 20/20 | A couple | H |
| | | | | | | of | |
| | | | | | | Scratches | |

The results in Tables 13 and 14 with different curing energies are similar to each other.

A third set of samples was prepared with seven samples including 5 with nanodiamonds and two without. This set of samples was prepared on PET films from Vampire Optical Coatings Inc. The hardcoats were cured with a curing energy of 450 mJ/cm². The results for these films are shown in Table 15.

TABLE 15

| | | | | | | Steel Wool | |
|---|---|---|---|---|---|---|---|
| | | | | | Adhesion | Test | |
| | Dry | Nano- | | | Test | (5 times by | Pencil |
| Sample | Thickness | diamond | TT % | Haze % | (Crosshatch) | hand) | Hardness |
| Bare | | | 90.9 | 0.36 | | Badly | |
| PET | | | | | | scratched | |
| 1 | 100 nm | Yes | 91.9 | 0.69 | 20/20 | Badly | F |
| | | | | | | Scratched | |
| 2 | 250 nm | Yes | 90.6 | 1.09 | 20/20 | Badly | F |
| | | | | | | scratched | |
| 3 | 500 nm | Yes | 91.1 | 0.28 | 20/20 | Badly | H |
| | | | | | | scratches | |
| 4 | 1000 nm | Yes | 91.1 | 0.82 | 20/20 | Some | H |
| | | | | | | scratches | |
| 5 | 2000 nm | Yes | 91.0 | 0.71 | 20/20 | A couple of | 4H |
| | | | | | | scratches | |
| 6 | 250 nm | No | 90.8 | 0.82 | 20/20 | Badly | F |
| | | | | | | Scratched | |
| 7 | 1000 nm | No | 91.1 | 0.93 | 20/20 | Few | H |
| | | | | | | Scratches | |

The results with the alternative PET substrate are similar to the results in Table 13.

The embodiments above are intended to be illustrative and not limiting. Additional embodiments are within the claims. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein.

1. A coating composition comprising:
at least about 7 weight percent organic solvent;
acrylate monomers having at least two acrylate functional groups;
epoxy functionalized polysiloxane with at least two epoxide groups;
epoxy functionalized aliphatic hydrocarbon compound;
a radical photoinitiator; and
a cationic photoinitiator,
having a solid content after removal of solvent of from about 0.5 weight percent to about 45 weight percent epoxy functionalized polysiloxane, and from about 10 weight percent to about 90 weight percent acrylate monomers with at least three acrylate functional groups and from about 0.25 weight percent to about 55 weight percent epoxy functionalized aliphatic hydrocarbon compound.

2. The coating composition of claim 1 wherein the solvent comprises a glycol ether.

3. The coating composition of claim 1 wherein the acrylate monomers have at least three acrylate functional groups.

4. The coating composition of claim 1 wherein the acrylate monomers comprise branched alkyl moieties.

5. The coating composition of claim 1 wherein the epoxy functionalized polysiloxane has three or more epoxide groups.

6. The coating composition of claim 1 wherein the epoxy functionalized aliphatic hydrocarbon comprises a polyglycidyl ether of aliphatic glycol.

7. The coating composition of claim 1 further comprising an acrylate functionalized polyurethane.

8. The coating composition of claim 1 wherein the epoxy functionalized polysiloxane comprise a polysiloxane cage.

9. The coating composition of claim 8 wherein each silicon atom of the cage structure is associated with a glycidyl ether group.

10. (canceled)

11. The coating composition of claim 1 further comprising based on a solid content following solvent removal from about 1 weight percent to about 50 weight percent of an acrylate functionalized polyurethane.

12. The coating composition of claim 1 further comprising from about 0.005 weight percent to about 5 weight percent nanoscale filler.

13. The coating composition of claim 12 wherein the nanoscale filler comprises nanodiamond with an average particle size of no more than about 50 nm.

14-29. (canceled)

30. The coating composition of claim 1 wherein the acrylate monomers comprise compounds with five acrylate functional groups, six acrylate functional groups or combinations thereof.

31. The coating composition of claim 1 wherein the hydrocarbon backbone of the epoxy functionalized aliphatic hydrocarbon compound is halogenated.

32. The coating composition of claim 1 wherein the epoxy functionalize polysiloxane comprises an octagonal siloxane cage with an epoxy group at each silicone atom of the cage.

33. The coating composition of claim 1 having from about 0.5 wt % to about 8 wt % cationic photoinitiator comprising diaryliodium based catalyst or diarylsulfonium based catalyst, and from about 0.25 wt % to about 12 wt % radical photoinitator.

34. The coating composition of claim 1 wherein the polysiloxane has a molecular weight from about 800 g/mol to about 4000 g/mol.

35. The coating composition of claim 1 having a solid content after removal of solvent of from about 2 weight percent to about 35 weight percent epoxy functionalized polysiloxane, and from about 20 weight percent to about 82.5 weight percent acrylate monomers with at least three acrylate functional groups and from about 0.5 weight percent to about 45 weight percent epoxy functionalized aliphatic hydrocarbon compound.

36. The coating composition of claim 1 further comprising from about 0.01 wt % to about 5 weight percent nanodiamond.

37. The coating composition of claim 36 wherein the nanodiamonds have an average diameter of no more than about 50 nm.

38. The coating composition of claim 1 further comprising from about 0.00025 wt % to about 2 wt % nanoscale colorant.

39. The coating composition of claim 38 wherein the nanoscale colorant comprises nanoplates.
